(19) United States
(12) Patent Application Publication
(10) Pub. No.: US 2025/0274790 A1
(43) Pub. Date: Aug. 28, 2025

(54) PERFORMING CROSS-LINK INTERFERENCE MEASUREMENTS IN A FULL-DUPLEX COMMUNICATION MODE

(71) Applicant: QUALCOMM Incorporated, San Diego, CA (US)

(72) Inventors: Yuwei REN, Beijing (CN); Yan ZHOU, San Diego, CA (US); Qian ZHANG, Basking Ridge, NJ (US); Huilin XU, Temecula, CA (US)

(21) Appl. No.: 18/855,250

(22) PCT Filed: May 19, 2022
(86) PCT No.: PCT/CN2022/093819

§ 371 Date: Oct. 8, 2024

(51) Int. Cl. H04W 24/08; H04W 72/542

(52) U.S. Cl. CPC H04W 24/08; H04W 72/542

(57) ABSTRACT

Methods, systems, and devices for wireless communications are described. A user equipment (UE) may transmit a message to a network entity indicating a capability of the UE to support simultaneous uplink transmissions and cross-link interference (CLI) measurements on respective resources while operating in a full-duplex communication mode. The UE may perform a CLI measurement, an uplink transmission, or both in accordance with the capability. For example, the UE may perform both simultaneously or may prioritize either the CLI measurement or the uplink transmission. The CLI measurement and the uplink transmission may occur during resources that at least partially overlap in the time domain.

### CROSS REFERENCE

The present application is a 371 national phase filing of International PCT Application No. PCT/CN2022/093819 by REN et al., entitled “PERFORMING CROSS-LINK INTERFERENCE MEASUREMENTS IN A FULL-DUPLEX COMMUNICATION MODE,” filed May 19, 2022, which is assigned to the assignee hereof, and which is expressly incorporated by reference in its entirety herein.

### FIELD OF TECHNOLOGY

The following relates to wireless communications, including performing cross-link interference (CLI) measurements in a full-duplex communication mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, a wireless device may perform uplink and downlink transmissions in a full-duplex mode. However, in some cases, the uplink transmissions may overlap with a cross-link interference (CLI) measurement.

### SUMMARY

The described techniques relate to improved methods, systems, devices, and apparatuses that support performing cross-link interference (CLI) measurements in a full-duplex communication mode. For example, the described techniques provide for a user equipment (UE) to indicate a capability to support simultaneous uplink transmissions and CLI measurements in a full-duplex communication mode. A network entity may allocate resources for the CLI measurements, uplink transmissions, or both based on receiving the capability. For example, the network entity may provide resources for performing both the uplink transmissions and the CLI measurements simultaneously if the UE supports the simultaneous transmission and measurement. In some other examples, the network entity may provide different resources for the uplink transmissions and the CLI measurements if the UE supports either the transmission or the CLI measurement.

A method for wireless communication at a UE is described. The method may include transmitting a message indicating a capability of the UE to support simultaneous uplink transmissions and CLI measurements on respective resources while operating in a full-duplex communication mode and performing a CLI measurement or an uplink transmission, or both, in accordance with the capability, where the CLI measurement occurs during a first resource and the uplink transmission occurs during a second resource that at least partially overlaps in a time domain with the first resource.

An apparatus for wireless communication at a UE is described. The apparatus may include a processor, memory coupled with the processor, and instructions stored in the memory. The instructions may be executable by the processor to cause the apparatus to transmit a message indicating a capability of the UE to support simultaneous uplink transmissions and CLI measurements on respective resources while operating in a full-duplex communication mode and perform a CLI measurement or an uplink transmission, or both, in accordance with the capability, where the CLI measurement occurs during a first resource and the uplink transmission occurs during a second resource that at least partially overlaps in a time domain with the first resource.

Another apparatus for wireless communication at a UE is described. The apparatus may include means for transmitting a message indicating a capability of the UE to support simultaneous uplink transmissions and CLI measurements on respective resources while operating in a full-duplex communication mode and means for performing a CLI measurement or an uplink transmission, or both, in accordance with the capability, where the CLI measurement occurs during a first resource and the uplink transmission occurs during a second resource that at least partially overlaps in a time domain with the first resource.

A non-transitory computer-readable medium storing code for wireless communication at a UE is described. The code may include instructions executable by a processor to transmit a message indicating a capability of the UE to support simultaneous uplink transmissions and CLI measurements on respective resources while operating in a full-duplex communication mode and perform a CLI measurement or an uplink transmission, or both, in accordance with the capability, where the CLI measurement occurs during a first resource and the uplink transmission occurs during a second resource that at least partially overlaps in a time domain with the first resource.

Some examples of the method, apparatuses, and non-transitory computer-readable medium described herein may further include operations, features, means, or instructions for receiving a resource allocation for a set of multiple resources including the first resource, the set of multiple resources being associated with intra-cell CLI measurements, where the resource allocation may be based on the capability including a capability of the UE to support simultaneous intra-cell CLI measurements and uplink transmissions.

In some examples of the method, apparatuses, and non-transitory computer-readable medium described herein, performing the CLI measurement or the uplink transmission, or both may include operations, features, means, or instructions for performing an intra-cell CLI measurement during the first resource and the uplink transmission during the second resource based on the capability.

In some examples of the method, apparatuses, and non-transitory computer-readable medium described herein, a predetermined timing for performing the intra-cell CLI measurements on the set of multiple resources corresponds to an uplink transmission timing of the UE and performing the intra-cell CLI measurement during the first resource may be based on the predetermined timing.

Some examples of the method, apparatuses, and non-transitory computer-readable medium described herein may further include operations, features, means, or instructions for receiving a second message indicating a timing for performing the intra-cell CLI measurements on the set of multiple resources based on the resource allocation, where performing the intra-cell CLI measurement during the first resource may be based on the timing.

Some examples of the method, apparatuses, and non-transitory computer-readable medium described herein may further include operations, features, means, or instructions for receiving a resource allocation for a set of multiple resources including the first resource, respective resources of the set of multiple resources being associated with either intra-cell CLI measurements or inter-cell CLI measurements, where the resource allocation may be based on the capability and receiving a third message including an indication to perform the intra-cell CLI measurements or the inter-cell CLI measurements, where the indication may be based on the capability.

In some examples of the method, apparatuses, and non-transitory computer-readable medium described herein, performing the CLI measurement or the uplink transmission, or both may include operations, features, means, or instructions for performing an intra-cell CLI measurement during the first resource and the uplink transmission during the second resource based on the indication to perform the intra-cell CLI measurement, where the capability includes a capability of the UE to support simultaneous intra-cell CLI measurements and uplink transmissions and refraining from performing an inter-cell CLI measurement during a third resource from the set of multiple resources based on the capability and the indication.

Some examples of the method, apparatuses, and non-transitory computer-readable medium described herein may further include operations, features, means, or instructions for receiving a resource allocation for a set of multiple resources including the first resource, respective resources of the set of multiple resources being associated with either intra-cell CLI measurements or inter-cell CLI measurements, where the resource allocation may be based on the capability and receiving a third message including an indication of which resources of the set of multiple resources may be associated with the simultaneous uplink transmissions and the CLI measurements or associated with CLI measurements without simultaneous uplink transmissions, where the indication may be based on the capability.

In some examples of the method, apparatuses, and non-transitory computer-readable medium described herein, performing the CLI measurement or the uplink transmission, or both may include operations, features, means, or instructions for performing an intra-cell CLI measurement during the first resource and the uplink transmission during the second resource based on the third message including an indication to perform the intra-cell CLI measurement on the first resource, where the capability includes a capability of the UE to support simultaneous intra-cell CLI measurements and uplink transmissions.

In some examples of the method, apparatuses, and non-transitory computer-readable medium described herein, performing the CLI measurement or the uplink transmission, or both may include operations, features, means, or instructions for performing an inter-cell CLI measurement during a third resource of the set of multiple resources based on the third message indicating that the third resource may be associated with CLI measurements without simultaneous uplink transmissions and refraining from performing the uplink transmission during a fourth resource that at least partially overlaps with the third resource based on the capability and the indication.

Some examples of the method, apparatuses, and non-transitory computer-readable medium described herein may further include operations, features, means, or instructions for receiving a resource allocation for a set of multiple resources, the set of multiple resources including a first subset of resources associated with intra-cell CLI measurements and a second subset of resources associated with inter-cell CLI measurements.

In some examples of the method, apparatuses, and non-transitory computer-readable medium described herein, the first subset and the second subset correspond to different resource groups based on a timing gap between the intra-cell CLI measurements and the inter-cell CLI measurements being greater than a threshold duration.

In some examples of the method, apparatuses, and non-transitory computer-readable medium described herein, the first subset and the second subset correspond to a same resource group based on a timing gap between the intra-cell CLI measurements and the inter-cell CLI measurements being less than or equal to a threshold duration.

In some examples of the method, apparatuses, and non-transitory computer-readable medium described herein, the message indicating the capability includes a set of multiple bits, the set of multiple bits indicating a capability of the UE to support intra-cell CLI measurements, a capability of the UE to support inter-cell CLI measurements, a maximum timing difference between the CLI measurements and the uplink transmission, a CLI strength threshold, or any combination thereof.

In some examples of the method, apparatuses, and non-transitory computer-readable medium described herein, performing the CLI measurement or the uplink transmission, or both may include operations, features, means, or instructions for determining a timing difference between the first resource and the second resource may be greater than the maximum timing difference, refraining from performing the CLI measurement during the first resource, the second resource, or both, based on the second resource at least partially overlapping in the time domain with the first resource, and performing the uplink transmission during the second resource in accordance with the capability based on the timing difference.

Some examples of the method, apparatuses, and non-transitory computer-readable medium described herein may further include operations, features, means, or instructions for updating a coefficient for filtering CLI based on refraining from performing the CLI measurement during one or more CLI measurement occasions.

In some examples of the method, apparatuses, and non-transitory computer-readable medium described herein, performing the CLI measurement or the uplink transmission, or both may include operations, features, means, or instructions for performing the CLI measurement during at least a portion of the first resource to obtain a CLI strength, terminating the CLI measurement for a remaining portion of the first resource based on the CLI strength being below the CLI strength threshold, and performing the uplink transmission during the second resource in accordance with the capability and based on terminating the CLI measurement for the remaining portion of the first resource.

Some examples of the method, apparatuses, and non-transitory computer-readable medium described herein may further include operations, features, means, or instructions for updating a coefficient for filtering CLI based on terminating the CLI measurement during one or more CLI measurement occasions.

In some examples of the method, apparatuses, and non-transitory computer-readable medium described herein, performing the CLI measurement or the uplink transmission, or both may include operations, features, means, or instructions for performing the CLI measurement during the first resource in accordance with the capability and refraining from preforming the uplink transmission during the second resource in accordance with the capability.

In some examples of the method, apparatuses, and non-transitory computer-readable medium described herein, performing the CLI measurement or the uplink transmission, or both may include operations, features, means, or instructions for performing the uplink transmission during the second resource in accordance with the capability and refraining from preforming the CLI measurement during the first resource in accordance with the capability.

In some examples of the method, apparatuses, and non-transitory computer-readable medium described herein, the message indicating the capability may be different from another message including an indication of a capability of the UE to support the full-duplex communication mode.

In some examples of the method, apparatuses, and non-transitory computer-readable medium described herein, the message indicating the capability further includes an indication of a capability of the UE to support the full-duplex communication mode.

In some examples of the method, apparatuses, and non-transitory computer-readable medium described herein, the capability of the UE to support the simultaneous uplink transmissions and the CLI measurements may be based on the UE supporting the full-duplex communication mode.

A method for wireless communication at a network entity is described. The method may include receiving a message indicating a capability of a UE to support simultaneous uplink transmissions and CLI measurements on respective resources while operating in a full-duplex communication mode and receiving an uplink transmission during a first resource that at least partially overlaps in a time domain with a second resource configured for a CLI measurement in accordance with the capability.

An apparatus for wireless communication at a network entity is described. The apparatus may include a processor, memory coupled with the processor, and instructions stored in the memory. The instructions may be executable by the processor to cause the apparatus to receive a message indicating a capability of a UE to support simultaneous uplink transmissions and CLI measurements on respective resources while operating in a full-duplex communication mode and receive an uplink transmission during a first resource that at least partially overlaps in a time domain with a second resource configured for a CLI measurement in accordance with the capability.

Another apparatus for wireless communication at a network entity is described. The apparatus may include means for receiving a message indicating a capability of a UE to support simultaneous uplink transmissions and CLI measurements on respective resources while operating in a full-duplex communication mode and means for receiving an uplink transmission during a first resource that at least partially overlaps in a time domain with a second resource configured for a CLI measurement in accordance with the capability.

A non-transitory computer-readable medium storing code for wireless communication at a network entity is described. The code may include instructions executable by a processor to receive a message indicating a capability of a UE to support simultaneous uplink transmissions and CLI measurements on respective resources while operating in a full-duplex communication mode and receive an uplink transmission during a first resource that at least partially overlaps in a time domain with a second resource configured for a CLI measurement in accordance with the capability.

Some examples of the method, apparatuses, and non-transitory computer-readable medium described herein may further include operations, features, means, or instructions for transmitting a resource allocation for a set of multiple resources including the first resource, the set of multiple resources being associated with intra-cell CLI measurements, where the resource allocation may be based on the capability including a capability of the UE to support simultaneous intra-cell CLI measurements and uplink transmissions.

In some examples of the method, apparatuses, and non-transitory computer-readable medium described herein, a predetermined timing for performing the intra-cell CLI measurements on the set of multiple resources corresponds to an uplink transmission timing of the UE.

Some examples of the method, apparatuses, and non-transitory computer-readable medium described herein may further include operations, features, means, or instructions for transmitting a second message indicating a timing for performing the intra-cell CLI measurements on the set of multiple resources based on the resource allocation.

Some examples of the method, apparatuses, and non-transitory computer-readable medium described herein may further include operations, features, means, or instructions for transmitting a resource allocation for a set of multiple resources including the first resource, respective resources of the set of multiple resources being associated with either intra-cell CLI measurements or inter-cell CLI measurements, where the resource allocation may be based on the capability including a capability of the UE to support simultaneous intra-cell CLI measurements and uplink transmissions and transmitting a third message including an indication to perform the intra-cell CLI measurements or the inter-cell CLI measurements, where the indication may be based on the capability.

Some examples of the method, apparatuses, and non-transitory computer-readable medium described herein may further include operations, features, means, or instructions for transmitting a resource allocation for a set of multiple resources including the first resource, respective resources of the set of multiple resources being associated with either intra-cell CLI measurements or inter-cell CLI measurements, where the resource allocation may be based on the capability and transmitting a third message including an indication of which resources of the set of multiple resources may be associated with the simultaneous uplink transmissions and the CLI measurements or associated with CLI measurements without simultaneous uplink transmissions, where the indication may be based on the capability.

Some examples of the method, apparatuses, and non-transitory computer-readable medium described herein may further include operations, features, means, or instructions for transmitting a resource allocation for a set of multiple resources, the set of multiple resources including a first subset of resources associated with intra-cell CLI measurements and a second subset of resources associated with inter-cell CLI measurements.

In some examples of the method, apparatuses, and non-transitory computer-readable medium described herein, the first subset and the second subset correspond to different resource groups based on a timing gap between the intra-cell CLI measurements and the inter-cell CLI measurements being greater than a threshold duration.

In some examples of the method, apparatuses, and non-transitory computer-readable medium described herein, the first subset and the second subset correspond to a same resource group based on a timing gap between the intra-cell CLI measurements and the inter-cell CLI measurements being less than or equal to a threshold duration.

In some examples of the method, apparatuses, and non-transitory computer-readable medium described herein, the message indicating the capability includes a set of multiple bits, the set of multiple bits indicating a capability of the UE to support intra-cell CLI measurements, a capability of the UE to support inter-cell CLI measurements, a maximum timing difference between the CLI measurements and the uplink transmission, a CLI strength threshold, or any combination thereof.

In some examples of the method, apparatuses, and non-transitory computer-readable medium described herein, the capability includes an inability of the UE to support the simultaneous uplink transmissions and the CLI measurements.

In some examples of the method, apparatuses, and non-transitory computer-readable medium described herein, the message indicating the capability may be different from another message including an indication of a capability of the UE to support the full-duplex communication mode.

In some examples of the method, apparatuses, and non-transitory computer-readable medium described herein, the message indicating the capability further includes an indication of a capability of the UE to support the full-duplex communication mode.

In some examples of the method, apparatuses, and non-transitory computer-readable medium described herein, the capability of the UE to support the simultaneous uplink transmissions and the CLI measurements may be based on the UE supporting the full-duplex communication mode.

### BRIEF DESCRIPTION OF THE DRAWINGS

FIGS. 1 and 2 illustrate examples of wireless communications systems that support performing cross-link interference (CLI) measurements in a full-duplex communication mode in accordance with one or more aspects of the present disclosure.

FIGS. 3A and 3B illustrate examples of resource diagrams that support performing CLI measurements in a full-duplex communication mode in accordance with one or more aspects of the present disclosure.

FIG. 4 illustrates an example of a process flow in a system that supports performing CLI measurements in a full-duplex communication mode in accordance with one or more aspects of the present disclosure.

FIGS. 5 and 6 show block diagrams of devices that support performing CLI measurements in a full-duplex communication mode in accordance with one or more aspects of the present disclosure.

FIG. 7 shows a block diagram of a communications manager that supports performing CLI measurements in a full-duplex communication mode in accordance with one or more aspects of the present disclosure.

FIG. 8 shows a diagram of a system including a device that supports performing CLI measurements in a full-duplex communication mode in accordance with one or more aspects of the present disclosure.

FIGS. 9 and 10 show block diagrams of devices that support performing CLI measurements in a full-duplex communication mode in accordance with one or more aspects of the present disclosure.

FIG. 11 shows a block diagram of a communications manager that supports performing CLI measurements in a full-duplex communication mode in accordance with one or more aspects of the present disclosure.

FIG. 12 shows a diagram of a system including a device that supports performing CLI measurements in a full-duplex communication mode in accordance with one or more aspects of the present disclosure.

FIGS. 13 through 17 show flowcharts illustrating methods that support performing CLI measurements in a full-duplex communication mode in accordance with one or more aspects of the present disclosure.

### DETAILED DESCRIPTION

In some wireless communications systems, a network entity serving one or more user equipments (UEs) may implement full-duplex communications in which the network entity, the UE, or both, may transmit and receive concurrently. Additionally, or alternatively, the network entity may implement half-duplex communications in which the network entity, the UE, or both, may transmit and receive, but not concurrently. In full-duplex and half-duplex communications, downlink transmissions to and uplink transmissions from the one or more UEs may not be aligned in the time domain, which may cause interference at the network entity, the UE, or both. For example, the network entity may transmit and receive in a same or partially overlapping time-frequency resource as another wireless device (e.g., a UE), which may cause cross-link interference (CLI). For half-duplex communications, a UE may prioritize CLI measurement over an uplink transmission to a network entity. However, for full-duplex communications, the CLI measurement may collide with the uplink transmission to the network entity, causing transmission timing errors.

As described herein, a UE may transmit an indication to a network entity of a capability to support simultaneous CLI measurements and uplink transmissions (e.g., full-duplex CLI measurements) while in a full-duplex communication mode. The network entity may receive the indication of the capability and may configure one or more overlapping resources for one or more CLI measurements and uplink transmissions at the UE. For example, the network entity may configure the UE with inter-cell CLI measurement resources, intra-cell CLI measurement resources, or both. The UE may selectively perform the CLI measurements and uplink transmissions using the resources in accordance with the capability. In some cases, if the capability indicates that the UE supports the simultaneous uplink transmission and CLI measurement, the UE may perform both. In some other cases, if the capability indicates that the UE supports one of the CLI measurement or the uplink transmission, the UE may send the uplink transmission or perform the CLI measurement, but not both.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to performing CLI measurements in a full-duplex communication mode.

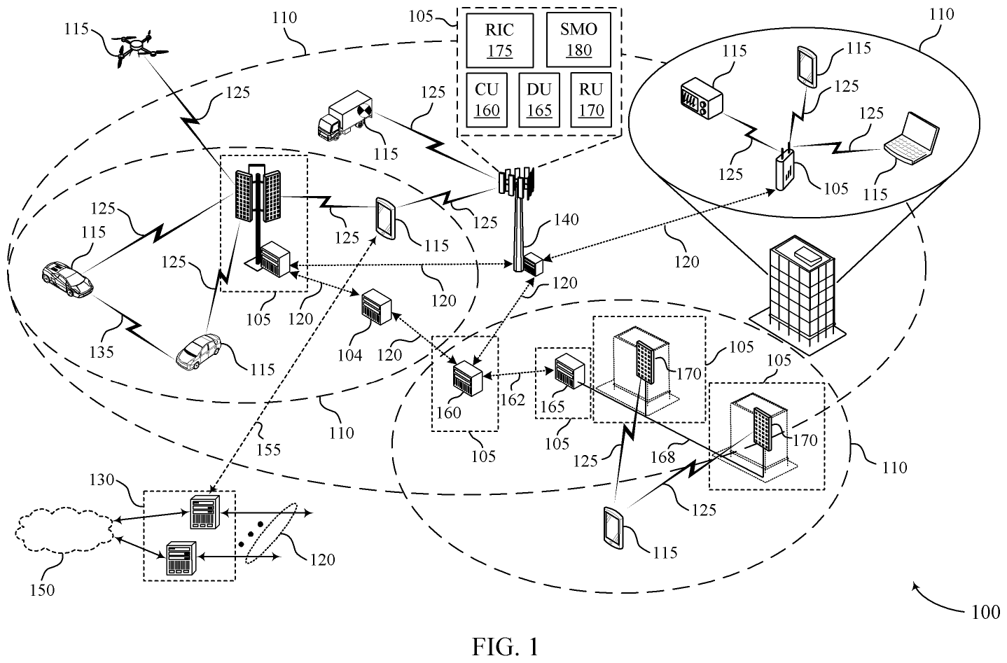

FIG. 1 illustrates an example of a wireless communications system 100 that supports performing CLI measurements in a full-duplex communication mode in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support performing CLI measurements in a full-duplex communication mode as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some cases, such as for wireless communications system 100, a network entity 105 serving one or more UEs 115 may support full-duplex communications or half-duplex communications, or both. Full-duplex communications may refer to a device (e.g., a UE 115, a network entity 105) that simultaneously transmits and receives messages, whereas half-duplex communications may refer to a device that may either transmit or receive at a given time. For full-duplex communications and half-duplex communications, downlink transmissions to and uplink transmissions from the one or more UEs 115 may not be aligned in time, which may cause interference at the network entity 105, the UE 115, or both. For example, the network entity 105 may transmit and receive in a same or partially overlapping time-frequency resource as another wireless device (e.g., a UE 115), which may cause CLI. For half-duplex communications, a UE 115 may prioritize a CLI measurement over an uplink transmission to a network entity 105. However, for full-duplex communications, the CLI measurement may collide with the uplink transmission to the network entity 105, causing transmission timing errors.

In some examples, to prevent the transmission timing errors, a UE 115 may transmit a capability message indicating a capability of the UE 115 to support simultaneous uplink transmissions and CLI measurements (e.g., intra-cell CLI measurements, inter-cell CLI measurements, or both). In some cases, the UE 115 may transmit the capability message to a network entity 105 as part of a full-duplex capability indication. In some other cases, the UE 115 may transmit the capability message to the network entity 105 independent of the full-duplex capability indication (e.g., in separate signaling). The CLI measurement capability indication may include one or more parameters, including a bit indicating whether the UE 115 supports the simultaneous CLI measurements and uplink transmissions. If the UE 115 supports the simultaneous CLI measurements and uplink transmissions, the network entity 105 may configure one or more resources for the UE 115 to concurrently perform both the CLI measurements and the uplink transmissions. If the UE 115 does not support the simultaneous CLI measurements and uplink transmissions, the UE 115 may prioritize either the uplink transmissions or the CLI measurements on the overlapping resources.

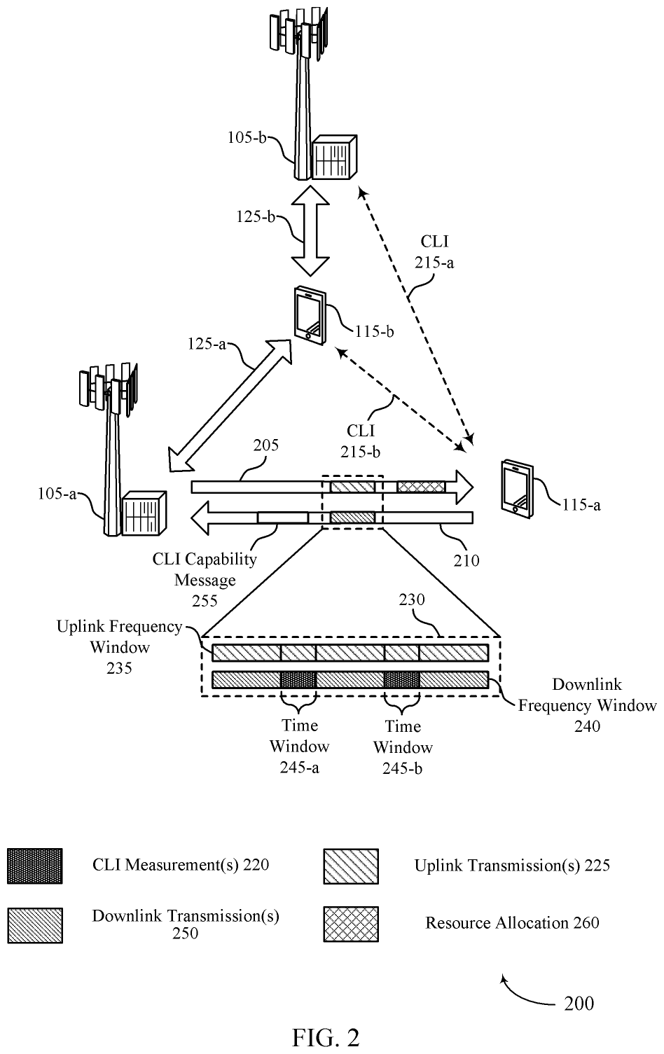

FIG. 2 illustrates an example of a wireless communications system 200 that supports performing CLI measurements in a full-duplex communication mode in accordance with one or more aspects of the present disclosure. The wireless communications system 200 may implement or be implemented to realize aspects of the wireless communications system 100. For example, the wireless communications system 200 illustrates communication between one or more UEs and network entities, such as a UE 115-a, a UE 115-b, a network entity 105-a, and a network entity 105-b, which may be examples of corresponding devices described herein, including with reference to FIG. 1. The wireless communications system 200 may support capability signaling that indicates whether a UE 115 (e.g., UE 115-a, UE 115-b) supports concurrent CLI measurements and uplink transmissions.

In some cases, the UE 115-a, the UE 115-b, or both may be in communication with the network entity 105-a and the network entity 105-b. For example, the network entity 105-a may transmit control information, data, or both to the UE 115-a via a downlink communication link 205. The UE 115-a may transmit control information, data or both to the network entity 105-a via an uplink communication link 210. Similarly, the UE 115-b may transmit or receive control information, data, or both to and from the network entity 105-a and the network entity 105-b via a communication link 125-a or a communication link 125-b, respectively, which may be examples of communication links 125 as described with reference to FIG. 1.

A wireless device (e.g., the network entity 105-a, the network entity 105-b, the UE 115-a, the UE 115-b) may operate in a full-duplex communication mode. In the full-duplex mode, the wireless device may transmit and receive at a same time. For example, if the network entity 105-a is operating in a full-duplex mode, the network entity 105-a may receive signaling from the UE 115-a via an uplink communication link 210 while concurrently or simultaneously transmitting signaling to the UE 115-b via the communication link 125-a. The UE 115-a may report a capability message to the network entity 105-a indicating a capability to support transmission and reception simultaneously. In some other examples, the wireless device may operate in a half-duplex mode in which the wireless device may transmit or receive data (e.g., not at the same time).

In some cases, the network entity 105-b and the network entity 105-a may transmit and receive signaling from the UE 115-a, the UE 115-b, or both in a same or overlapping frequency band, which may cause interference (e.g., CLI). For example, the network entity 105-b may transmit signaling to or receive signaling from the UE 115-b using resources (e.g., time-frequency resources) that may cause interference for (e.g., interfere with) signaling between the network entity 105-a and the UE 115-a, such as CLI 215-a. Similarly, the network entity 105-a may transmit signaling to or receive signaling from the UE 115-b and the UE 115-a in a same or overlapping frequency band, which may cause interference (e.g., CLI). For example, the network entity 105-a may transmit signaling to or receive signaling from the UE 115-b using resources that may cause interference for signaling between the network entity 105-a and the UE 115-a, such as CLI 215-b. CLI between one or more UEs 115 communicating with a same serving cell, such a cell associated with network entity 105-a or network entity 105-b, may be referred to as intra-cell CLI. CLI between one or more UEs 115 communicating with different serving cells, such as respective cells associated with network entity 105-a and/or network entity 105-b, may be referred to as inter-cell CLI.

In some examples, the UE 115-a may measure a level of CLI from CLI 215-a, CLI 215-b, or both. The duration for performing the CLI measurement 220 may overlap with one or more time resources, such as symbols (e.g., flexible symbols, which may be allocated for uplink or downlink), for transmitting to the network entity 105-a. Thus, the UE 115-a may prioritize one of the CLI measurement 220 or one or more uplink transmissions 225. For example, the UE 115-a may prioritize one or more CLI measurements 220 over one or more uplink transmissions 225. If the UE 115-a prioritizes the CLI measurements 220 or the uplink transmissions 225, the UE 115-a may be operating using a half-duplex mode in which the UE 115-a may perform one of the CLI measurement 220 or the uplink transmissions 225 at a time, t. However, in full-duplex communications, the CLI measurements 220 may collide with the uplink transmissions 225 to the network entity 105-a, causing transmission timing errors.

In some examples, to enable CLI measurements 220 in a full-duplex mode, the UE 115-a may report a capability to support simultaneous uplink transmission 225 and CLI measurements 220. In the full-duplex mode, there may be two separate frequency windows (e.g., fast Fourier transform (FFT) windows), such as one for transmission and another for reception. For example, the time-frequency resources 230 may include an uplink frequency window 235 and a downlink frequency window 240. In some cases, the UE 115-a may perform the uplink transmission 225 and CLI measurement 220 at the same time in the different FFT windows. For example, the UE 115-a may perform the uplink transmission 225 in the uplink frequency window 235 and the CLI measurement 220 in the downlink frequency window 240, both in a time window 245-a or time window 245-b.

In the full-duplex mode, the network entity 105-a may schedule a downlink reception of one or more downlink transmissions 250 and the one or more uplink transmissions 225. For example, the network entity 105-a may transmit control signaling (e.g., a downlink control information (DCI) message, a medium access control-control element (MAC-CE), or the like) including scheduling information for the uplink transmissions 225 and the downlink transmission 250 in the time-frequency resources 230. The CLI measurement at the UE 115-a may be based on an uplink transmission between the network entity 105-a and the UE 115-b or the network entity 105-b and the UE 115-b, where the UE 115-b may be referred to an aggressor UE. The aggressor UE may be in a neighboring cell (e.g., outside of the coverage area of UE 105-a).

In some examples, the UE 115-a may create additional interference (e.g., self-interference (SI)) for a transmission based on receiving or for a reception based on transmitting. Aligning a timing of a transmission symbol and a reception symbol may be beneficial to mitigate SI (e.g., an inter-symbol interference (ISI) component in SI), where a symbol may be a time unit for communications. In some examples, the UE 115-a may use a cyclic prefix (CP) duration, a same CP type (e.g., a normal CP (NCP) or an extended CP (ECP)), a same subcarrier spacing (SCS), alignment of a subcarrier grid of transmission and reception signals, or any combination thereof, to align the symbols and reduce or mitigate ISI. A CP may be a portion of a previous symbol appended before a current symbol. For example, to reduce ISI, a transmission and reception symbol timing difference at the UE 115-a may be relatively small compared to a CP duration. However, for full-duplex communications, aligning the transmission and reception may be difficult due to the uplink signals being aligned at the network entity 105-a. That is, for accurate timing adjustments, both the network entity 105-a and the UE 115-a may ensure the alignment between transmission and reception.

In some cases, the network entity 105-a may be unable to fully align the timing between downlink and uplink signals to avoid ICI in SI due to a timing advance condition at the UE 115-a. For example, the timing advance to eliminate interference among uplink and downlink signals may exceed an available time. For a CLI measurement 220, the receive timing of a CLI measurement resource may be determined based on a constant offset relative to the downlink reference timing for the network entity 105-a, where the UE 115-a may derive the constant offset value. In some examples, a timing difference between a CLI measurement and an uplink symbol may be relatively small, which may provide for approximately simultaneous CLI measurement 220 and uplink transmission 225. For intra-cell CLI, receive timing of a CLI measurement may be similar to, or the same as, a serving cell uplink timing for the UE 115-a or the UE 115-b, because CLI may emerge when the aggressor and victim UEs are close and propagation delay between them is negligible. For intra-cell CLI there may not be SI for a full-duplex CLI measurement.

For inter-cell CLI, if a size difference of coverage areas for neighboring serving cells (e.g., the network entity 105-a and the network entity 105-b) is relatively small compared with the size of the coverage area, the SI may be negligible for a full-duplex CLI measurement. However, if the two coverage areas for the network entity 105-a and the network entity 105-b have relatively different sizes (e.g., one is macro cell and the other one is micro cell), the timing relationship between receive timing of a CLI measurement 220 and transmission of a serving cell uplink signal or channel may correlate to the SI for the full-duplex CLI measurement. For example, a timing misalignment between a CLI measurement 220 and a signal or channel to the network entity 105-a may cause SI from communications with the network entity 105-a.

In some cases, there may not be a power control mechanism at the UE 115-a for the reception of the CLI measurement resource, which may be a time-frequency resource used for CLI measurements 220. The network entity 105-a may perform power control to compensate for a pathloss in a downlink transmission 250. A level of reception power may be relatively stable, but an interference power of CLI, such as CLI 215-a or CLI 215-b, may have a relatively large variation. In some cases, predicting a range of a CLI in advance may be difficult. For example, the CLI power may be related to a transmission power of an aggressor UE or network entity (e.g., a UE 115-b or network entity 105-b). The CLI power may be related to a range (e.g., pathloss) between a victim UE, such as UE 115-a, and the aggressor UE or network entity. Thus, the UE 115-a indicating that it supports full-duplex communications (e.g., a capability indication that excludes an indication that the UE 115-a supports simultaneous CLI measurements and uplink transmissions) may not be sufficient for performing CLI in a full-duplex deployment.

As described herein, the network entity 105-a may use dedicated capability signaling to enable CLI measurements for full-duplex communications, where the dedicated capability signaling may be referred to as a CLI capability message 255. In some examples, the UE 115-a may transmit a CLI capability message 255 to indicate to the network entity 105-a that the UE 115-a supports simultaneous uplink transmissions 225 and CLI measurements 220 on respective time-frequency resources while operating in a full-duplex communication mode. In some cases, the CLI capability message 255 may be independent of a full-duplex capability message, such that the UE 115-a may independently report a full-duplex capability message and the CLI capability message 255. In some other cases, the CLI capability message 255 may be one or more components of the full-duplex capability message. That is, the UE 115-a may add one or more parameters (e.g., bits dedicated for the CLI capability component) to the full-duplex capability message including the CLI capability message 255. Additionally, or alternatively, the UE 115-a may include a separate full-duplex CLI measurement capability dependent on a regular full-duplex UE capability. For example, when the UE 115-a supports full-duplex, the UE 115-a may also support the simultaneous CLI measurements 220 and uplink transmissions 225. That is, the UE 115-a may use a full-duplex capability as a prerequisite for a CLI capability message 255.

In some examples, the CLI capability message 255 may include one or more components, which may each span a number of bits in a transmission to the network entity 105-a. The one or more components may include a bit to indicate whether the UE supports the CLI measurements 220 and the uplink transmissions 225 in the full-duplex communication mode. If the UE 115-a does support the full-duplex CLI measurements 220, the one or more components may include a component to indicate whether inter-cell CLI measurements are supported, a component to indicate whether intra-cell CLI measurements are supported, a component to indicate a threshold (e.g., maximum) timing difference between a CLI measurement 220 and an uplink transmission 225, a component to indicate an effective CLI interference strength threshold, or any combination thereof. In some cases, if the timing difference exceeds the threshold timing difference, the UE 115-a may not perform the CLI measurement 220 together with the uplink transmission 225. The CLI interference strength threshold may indicate a minimum CLI interference that may cause performance degradation to the downlink reception at the UE 115-a. The threshold may be configured or otherwise defined at the UE 115-a. If the CLI interference strength is below the threshold, the UE 115-a may deactivate the CLI measurement 220 for a current CLI measurement resource (e.g., because the CLI may not impact the performance of signaling at the UE 115-a). The UE 115-a may wait to reactivate the CLI measurement 220 until receiving an indication from the network entity 105-a.

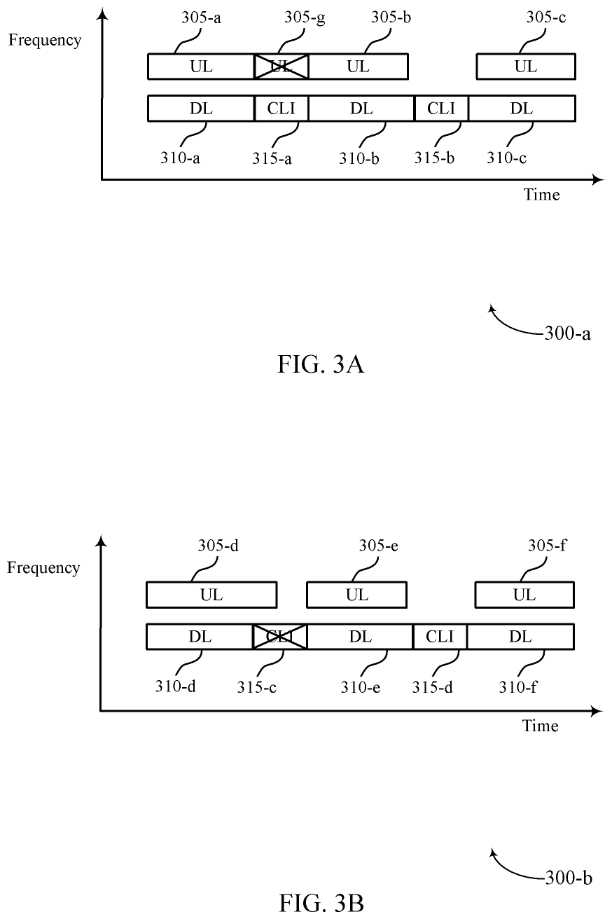

In some cases, if the CLI capability message 255 indicates that the UE 115-a does not support the simultaneous CLI measurement 220 and uplink transmission 225 in a full-duplex mode, the UE 115-a may prioritize the CLI measurement 220, which is described in further detail with respect to FIG. 3A. In some other cases, if the UE 115-a may prioritize the uplink transmissions 225, which is described in further detail with respect to FIG. 3B. If the CLI capability message 255 indicates that the UE 115-a supports the simultaneous CLI measurements 220 and the uplink transmissions 225, the UE 115-a may continue to prioritize the uplink transmissions 225 (e.g., serving signal and channel transmission) when the CLI does not meet the conditions of the UE capability, such as the CLI interference strength threshold, the maximum timing difference, or the like.

For example, UE 115-a may transmit the CLI capability message 255 indicating that the UE 115-a supports the simultaneous CLI measurements 220 and the uplink transmissions 225 to the network entity 105-a. The UE 115-a may determine a CLI interference strength of the CLI 215-a, the CLI 215-b, or both during a time window 245-a satisfies the CLI interference strength threshold, and may perform the CLI measurements 220 and the uplink transmissions 225 during the time window 245-a. However, the UE 115-a may determine a CLI interference strength of the CLI 215-a, the CLI 215-b, or both during a time window 245-b fails to satisfy the CLI interference strength threshold (e.g., is below the threshold). The UE 115-a may prioritize the uplink transmissions 225 during the time window 245-b and may refrain from performing the CLI measurements 220 based on the CLI interference strength being below the threshold. That is, the UE 115-a may skip one or more CLI measurement occasions (e.g., a time window 245-a or time window 245-b during which the UE 115-a performs a CLI measurement 220) when prioritizing the uplink transmission 225 or when a CLI does not meet conditions of the UE capability.

In some cases, for a CLI measurement 220, the UE 115-a may filter an instantaneous measurement result using Equation 1:

$$F ( n ) = ( 1 - a ) * F ( n - 1 ) + a * M ( n ) \qquad ( 1 )$$

where a coefficient, a, adapts the filter such that one or more time characteristics of the filter may be preserved at different input rates, M(n) is an instantaneous CLI measurement and F(n) is the filter output. If the UE 115-a skips CLI measurement occasions, the input rate of the filter may change. The UE 115-a may adjust the filter coefficient after skipped CLI measurement occasions, such that the time characteristics of the filter may be preserved at different input rates. In some cases, for an instantaneous CLI measurement after a measurement occasion that the UE 115-a may not skip, the filter coefficient may be a. In some other cases, for an instantaneous CLI measurement after one or more skipped measurement occasions, the filter may have an updated coefficient, as. In some examples, the updated coefficient may be proportional to the number of measurement occasions that are skipped by the UE 115-a.

In some examples, the CLI measurements 220 may be intra-cell CLI measurements, inter-cell CLI measurements, or both. A UE 115-a, a network entity 105-a, or both may approximate an intra-cell CLI timing as the uplink transmission timing, which may be sufficient for the CLI measurement 220. However, for inter-cell CLI, the CLI timing may differ from the uplink transmission timing. Instead, the network entity 105-a may estimate the inter-cell CLI timing of a neighboring cell, such as neighboring network entity 105-b, based on a timing advance of an aggressor UE, such as UE 115-b. When the CLI capability message 255 indicates that the UE 115-a supports simultaneous CLI measurements 220 and uplink transmissions 225, the CLI capability message 255 may additionally indicate whether intra-cell CLI measurement, inter-cell CLI measurement, or both are supported.

For example, the CLI capability message 255 may include an indication that the UE 115-a does not support inter-cell CLI measurements in a full-duplex communication mode. In some cases, the network entity 105-a may transmit a resource allocation 260 for the CLI measurements 220 that configures intra-cell CLI measurement resources, but not inter-cell CLI measurements based on the CLI capability message 255. In the resource allocation 260, the default CLI timing may be an uplink transmission timing for the UE 115-a. Additionally, or alternatively, the network entity 105-a may indicate the intra-cell timing in the resource allocation 260. The network entity 105-a may transmit the resource allocation 260 in control signaling (e.g., RRC signaling, a DCI message, a MAC-CE, or the like) to the UE 115-a. In some other cases, the network entity 105-a may include both inter-cell and intra-cell measurement resources in the resource allocation 260, and the UE 115-a may selectively perform the intra-cell CLI measurement in accordance with the CLI capability message 255. Additionally, or alternatively, the network entity 105-a may indicate which CLI resource(s) the UE 115-a may use to perform the CLI measurements 220 in the resource allocation 260. For instance, the indication of which CLI resource(s) the UE 115-a may use to perform the CLI measurements 220 may include an index of one or more resources that the UE 115-a uses for simultaneously sending the uplink transmission 225 and performing the CLI measurement 220.

In some other examples, the CLI capability message 255 may include an indication that the UE 115-a does support inter-cell CLI measurements and intra-cell CLI measurements in a full-duplex communication mode. The network entity 105-a may transmit a resource allocation 260 that configures separate CLI resource groups for intra-cell and inter-cell measurements. For example, when the timing gap between intra-cell and inter-cell CLI is large enough (e.g., above a threshold value), the network entity 105-a may configure an intra-cell resource group with the resource allocation 260 and a transmission timing as a CLI timing. Additionally, or alternatively, the network entity 105-a may configure one or more inter-cell resource groups for inter cell CLI measurements and a common CLI timing for each inter-cell CLI measurement in the resource allocation 260. In some cases, the UE 115-a may determine the inter-cell CLI timing independent of the network entity 105-a (e.g., based on UE self-implementation).

If a timing difference between two resources in the resource allocation 260 is relatively small (e.g., below a threshold value), the network entity 105-a may configure the two resources within a same resource group with a common CLI timing configuration. If the timing difference between the two resources in the resource allocation 260 is relatively large (e.g., above the threshold value), the network entity 105-a may configure the two resources in different resource groups with different CLI timing configurations. For example, the network entity 105-a may enable intra-cell CLI when the UE 115-a is operating in a full-duplex mode. When there is collision between an inter-cell measurement occasion and an uplink transmission occasion, the network entity 105-a may expect either an inter-cell CLI measurement or an uplink transmission 225 based on a configuration in the resource allocation 260 or the CLI capability message 255.

FIGS. 3A and 3B illustrate examples of a resource diagram 300-a and a resource diagram 300-b, respectively, that support performing CLI measurements in a full-duplex communication mode in accordance with one or more aspects of the present disclosure. In some examples, the resource diagram 300-a and the resource diagram 300-b may implement aspects of wireless communications system 100 and wireless communications system 200. For example, the resource diagram 300-a and the resource diagram 300-b may be implemented by a wireless communications system in which a UE indicates a capability to support simultaneous CLI measurements and uplink transmissions in a full-duplex mode to a network entity, where the network entity and UE may be examples of the corresponding devices as described with reference to FIGS. 1 and 2.

In some cases, a UE may operate in a full-duplex mode in which the UE transmits and receives concurrently. For example, the UE may transmit uplink transmission 305-a through uplink transmission 305-f while receiving downlink transmission 310-a through downlink transmission 310-f, respectively. Similarly, the UE may be capable of supporting simultaneous uplink transmissions during CLI measurement 315-a through CLI measurement 315-d. The UE may indicate the capability to the network entity. The duration in which the UE performs the CLI measurement may be referred to as a CLI measurement occasion.

In some examples, a UE may indicate to a network entity that the UE does not support simultaneous CLI measurements and uplink transmissions in a full-duplex mode. For example, the UE may transmit a capability message (e.g., either as part of full-duplex capability messaging or in an independent capability message) that indicates to the network entity that the UE does not support the simultaneous one or more CLI measurements and the one or more uplink transmissions, as described with reference to FIG. 2. In some cases, when the capability indicates that the simultaneous CLI measurements and uplink transmissions in full-duplex are not supported, the UE may prioritize either the CLI measurements or the uplink transmissions.

For example, as illustrated in FIG. 3A, the UE may prioritize a CLI measurement 315-a that overlaps with an uplink transmission 305-g in the time domain. The UE may cancel the uplink transmission 305-g, such that the UE may perform the CLI measurement 315-a and not the uplink transmission 305-g. A network entity may not expect an uplink transmission 305-g that overlaps with the CLI measurement 315-a based on receiving the CLI measurement capability messaging from the UE. If there is no uplink transmission scheduled to overlap with the CLI measurements, such as for CLI measurement 315-b, the UE may continue to perform the CLI measurement 315-b.

In some other examples, as illustrated in FIG. 3B, the UE may prioritize an uplink transmission 305-d that overlaps with a CLI measurement 315-c in the time domain. The UE may cancel the CLI measurement 315-c, such that the UE may perform the uplink transmission 305-d and not the CLI measurement 315-c. If there is no uplink transmission scheduled to overlap with the CLI measurements, such as for CLI measurement 315-d, the UE may continue to perform the CLI measurement 315-d.

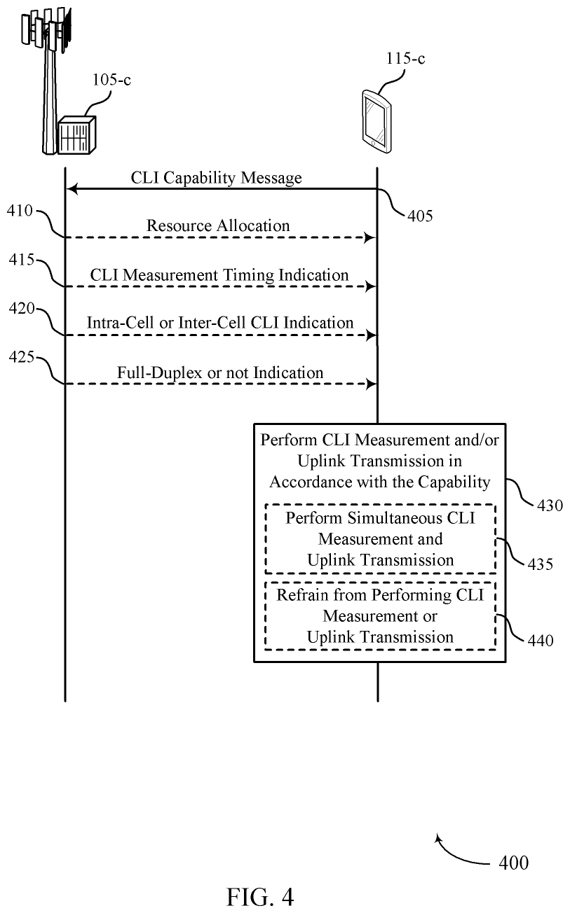

FIG. 4 illustrates an example of a process flow 400 in a system that supports performing CLI measurements in a full-duplex communication mode in accordance with one or more aspects of the present disclosure. In some examples, the process flow 400 may implement aspects of wireless communications system 100, wireless communications system 200, resource diagram 300-a, and resource diagram 300-b. The process flow 400 may illustrate an example of a UE 115-c indicating a capability to support a CLI measurement and uplink transmission in a full-duplex communication mode to a network entity 105-c. Network entity 105-c and UE 115-c may be examples of a network entity 105 and a UE 115 as described with reference to FIGS. 1 and 2. Alternative examples of the following may be implemented, where some processes are performed in a different order than described or are not performed. In some cases, processes may include additional features not mentioned below, or further processes may be added.

At 405, UE 115-c may transmit a message indicating a capability of the UE 115-c to support simultaneous uplink transmissions and CLI measurements on respective resources while operating in a full-duplex communication mode. The full-duplex communication mode may provide for the UE 115-c to transmit and receive concurrently, or simultaneously. The UE 115-c may transmit the message to the network entity 105-c in uplink control information.

In some cases, the message indicating the capability may include one or more components, or bits. The bits may indicate a capability of the UE to support intra-cell CLI measurements, a capability of the UE to support inter-cell CLI measurements, a maximum timing difference between the CLI measurements and the uplink transmission, a CLI strength threshold, or any combination thereof. In some cases, the UE 115-c may transmit the message indicating the capability independent from another message indicating a capability of the UE 115-c to support the full-duplex communication mode. In some other cases, the UE 115-c may transmit the message indicating the capability included in an indication of a capability of the UE 115-c to support the full-duplex communication mode. The UE 115-c may support the simultaneous uplink transmissions and the CLI measurements if the UE 115-c also supports the full-duplex communication mode.

In some examples, at 410, the UE 115-c may receive a resource allocation from the network entity 105-c. The resource allocation may indicate, or otherwise configure, one or more time-frequency resources for the CLI measurements, the uplink transmissions, or both. For example, the resource allocation may indicate resources for intra-cell CLI measurements, where the UE 115-c supports simultaneous intra-cell CLI measurements and uplink transmissions. In some other examples, the resource allocation may indicate resources for either intra-cell CLI measurements or inter-cell CLI measurements in accordance with the capability of the UE 115-c to support intra-cell CLI measurements, inter-cell CLI measurements, or both.

In some examples, the UE 115-c may receive a resource allocation indicating resources for either intra-cell CLI measurements or inter-cell CLI measurements based on the capability of the UE 115-c to support intra-cell CLI measurements, inter-cell CLI measurements, or both. For example, if the UE 115-c supports intra-cell CLI measurements, but not inter-cell CLI measurements, the network entity 105-c may configure resources for the intra-cell CLI measurements. Similarly, if the UE 115-c supports both intra-cell CLI measurements and inter-cell CLI measurements, the network entity 105-c may configure resources for the intra-cell CLI measurements, the inter-cell CLI measurements, or both.

In some cases, the UE 115-c may receive a resource allocation from the network entity 105-c indicating one or more subsets of resources. A subset of resources may be for intra-cell CLI measurements and another subset of resources may be for inter-cell CLI measurements. In some examples, the subsets may belong to different resource groups based on a timing gap between the intra-cell CLI measurements and the inter-cell CLI measurements being greater than a threshold duration. In some other examples, the subsets may belong to a same resource group based on a timing gap between the intra-cell CLI measurements and the inter-cell CLI measurements being less than or equal to a threshold duration. The threshold duration may be defined at the UE 115-c either via control signaling from the network entity 105-c or otherwise configured at the UE 115-c.

At 415, UE 115-c may receive a message from the network entity 105-c indicating a timing for performing the intra-cell CLI measurements on the resources. The network entity 105-c may include the timing information in the resource allocation or in an independent message.

At 420, UE 115-c may receive a message from the network entity 105-c indicating for the UE 115-c to perform intra-cell CLI measurements or inter-cell CLI measurements in accordance with the capability of the UE 115-c. In such cases, resource allocation at 410 may indicate a configuration of both inter-cell and intra-cell CLI measurement resources, and the message at 420 may indicate whether to perform inter-cell or intra-cell CLI measurements using the corresponding resources based on the capability of the UE 115-c.

At 425, the UE 115-c may receive a message from the network entity 105-c indicating which resources of the resource allocation are for a simultaneous uplink transmission and the CLI measurement or for CLI measurements without simultaneous uplink transmissions. For example, the message may indicate one or more resources that are associated with simultaneous uplink transmissions and CLI measurements. Additionally, or alternatively, the message may indicate one or more resources that are associated with either uplink transmissions or CLI measurements.

At 430, the UE 115-c may perform a CLI measurement, an uplink transmission to the network entity 105-c, or both in accordance with the capability of the UE 115-c. The CLI measurement may occur during one or more resources that at least partially overlap in a time domain with resources for the uplink transmission.

At 435, the UE 115-c may perform a simultaneous CLI measurement and uplink transmission based on the capability of the UE 115-c to support both.

At 440, the UE 115-c may refrain from performing the CLI measurement or the uplink transmission based on not supporting simultaneous CLI measurements and uplink transmissions. That is, the UE 115-c may prioritize either the CLI measurement or the uplink transmission during the resources.

In some cases, the UE 115-c may perform an intra-cell CLI measurement during a resource and the uplink transmission during another resource based on the UE 115-c supporting the simultaneous CLI measurement and uplink transmission. For example, the UE 115-c may perform the intra-cell CLI measurement in accordance with the timing in the timing indication from 415. Additionally, or alternatively, the UE 115-c may use a predetermined, or otherwise defined, timing for performing the intra-cell CLI measurements.

The UE 115-c may perform an intra-cell CLI measurement and uplink transmission during the resources based on the network entity 105-c indicating for the UE 115-c to perform the intra-cell CLI measurement. The UE 115-c may refrain from performing an inter-cell CLI measurement during another resource based on the capability of the UE 115-c and the indication from the network entity 105-c at 420 indicating for the UE 115-c to perform intra-cell CLI.

The UE 115-c may perform a simultaneous intra-cell CLI measurement and uplink transmission based on receiving a message indicating for the UE 115-c to perform the intra-cell CLI measurement. The UE 115-c may perform the intra-cell CLI measurement based on transmitting a capability of the UE 115-c to support simultaneous intra-cell CLI measurements and uplink transmissions. In some cases, the UE 115-c may perform an inter-cell CLI measurement during an additional resource based on the network entity 105-c indicating that the additional resource is for CLI measurements without simultaneous uplink transmissions. The UE 115-c may refrain from performing the uplink transmission during a resource that at least partially overlaps with the inter-cell CLI in accordance with the capability.

In some examples, the UE 115-c may determine a timing difference between resources for the CLI measurement and the uplink transmission is greater than a threshold (e.g., maximum) timing difference. The UE 115-c may refrain from performing the CLI measurement during the overlapping resources. The UE 115-c may perform the uplink transmission during at least one of the overlapping resources based on the timing difference exceeding the maximum timing difference. The UE 115-c may update a coefficient for filtering CLI based on refraining from performing the CLI measurement during one or more CLI measurement occasions.

In some other examples, the UE 115-c may perform the CLI measurement during at least a portion of an overlapping resource to obtain a CLI strength. The UE 115-c may terminate the CLI measurement for a remaining portion of the resource based on the CLI strength being below the CLI strength threshold. In some cases, the UE 115-c may perform the uplink transmission during another overlapping resource in accordance with the capability and based on terminating the CLI measurement for the remaining portion of the first resource. The UE 115-c may update a coefficient for filtering CLI based on terminating the CLI measurement during one or more CLI measurement occasions.

In some cases, the capability message may indicate an inability of the UE 115-c to support the simultaneous uplink transmissions and the CLI measurements. In some examples, the UE 115-c may prioritize the CLI measurements accordingly by performing the CLI measurement during the overlapping resources and refraining from preforming the uplink transmission during the overlapping resources. In some other examples, the UE 115-c may prioritize the uplink transmissions by performing the uplink transmission during the overlapping resources and refraining from preforming the CLI measurement during the overlapping resources.

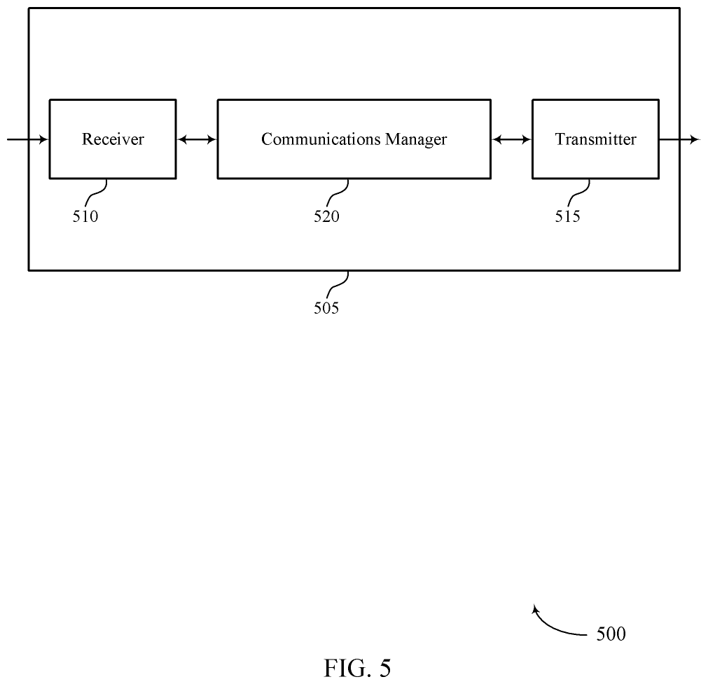

FIG. 5 shows a block diagram 500 of a device 505 that supports performing CLI measurements in a full-duplex communication mode in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to performing CLI measurements in a full-duplex communication mode). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to performing CLI measurements in a full-duplex communication mode). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of performing CLI measurements in a full-duplex communication mode as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting a message indicating a capability of the UE to support simultaneous uplink transmissions and CLI measurements on respective resources while operating in a full-duplex communication mode. The communications manager 520 may be configured as or otherwise support a means for performing a CLI measurement or an uplink transmission, or both, in accordance with the capability, where the CLI measurement occurs during a first resource and the uplink transmission occurs during a second resource that at least partially overlaps in a time domain with the first resource.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for a UE to indicate a capability to support a CLI measurement and uplink transmission in a full-duplex communication mode to a network entity, which may provide for reduced processing, reduced power consumption, more efficient utilization of communication resources, and the like.

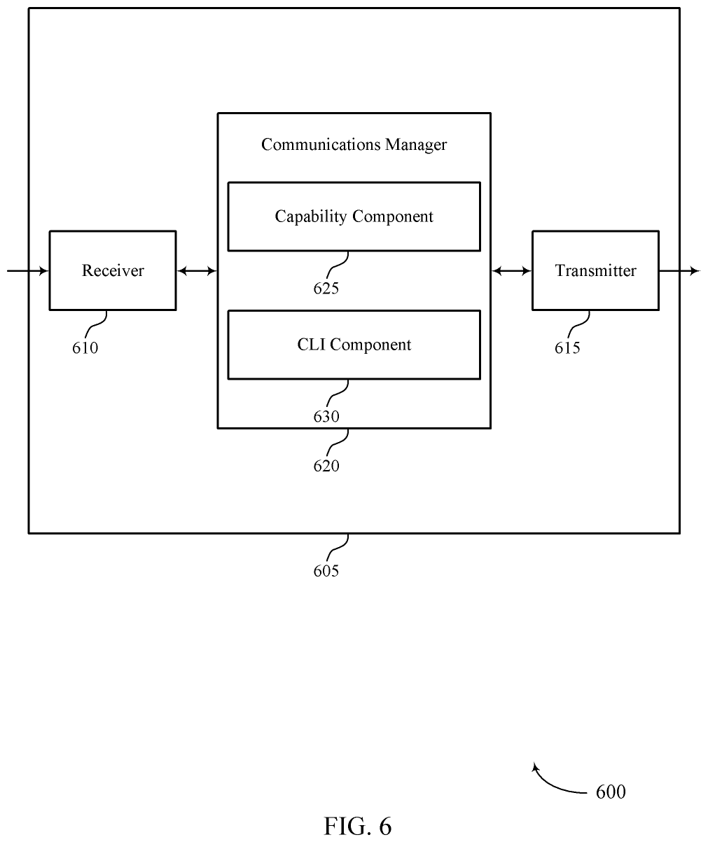

FIG. 6 shows a block diagram 600 of a device 605 that supports performing CLI measurements in a full-duplex communication mode in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to performing CLI measurements in a full-duplex communication mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to performing CLI measurements in a full-duplex communication mode). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of performing CLI measurements in a full-duplex communication mode as described herein. For example, the communications manager 620 may include a capability component 625 a CLI component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The capability component 625 may be configured as or otherwise support a means for transmitting a message indicating a capability of the UE to support simultaneous uplink transmissions and CLI measurements on respective resources while operating in a full-duplex communication mode. The CLI component 630 may be configured as or otherwise support a means for performing a CLI measurement or an uplink transmission, or both, in accordance with the capability, where the CLI measurement occurs during a first resource and the uplink transmission occurs during a second resource that at least partially overlaps in a time domain with the first resource.

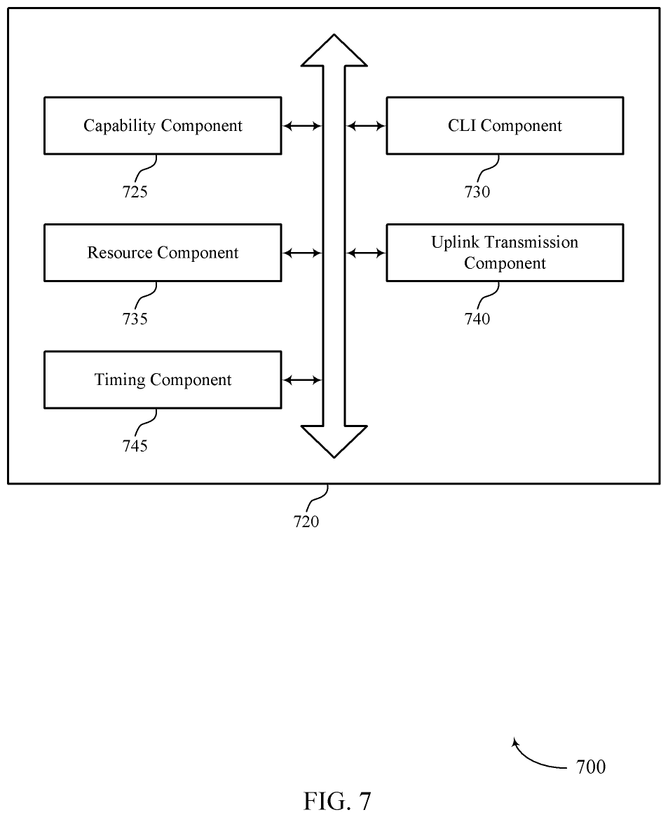

FIG. 7 shows a block diagram 700 of a communications manager 720 that supports performing CLI measurements in a full-duplex communication mode in accordance with one or more aspects of the present disclosure. The communications manager 720 may be an example of aspects of a communications manager 520, a communications manager 620, or both, as described herein. The communications manager 720, or various components thereof, may be an example of means for performing various aspects of performing CLI measurements in a full-duplex communication mode as described herein. For example, the communications manager 720 may include a capability component 725, a CLI component 730, a resource component 735, an uplink transmission component 740, a timing component 745, or any combination thereof. Each of these components may communicate, directly or indirectly, with one another (e.g., via one or more buses).

The communications manager 720 may support wireless communication at a UE in accordance with examples as disclosed herein. The capability component 725 may be configured as or otherwise support a means for transmitting a message indicating a capability of the UE to support simultaneous uplink transmissions and CLI measurements on respective resources while operating in a full-duplex communication mode. The CLI component 730 may be configured as or otherwise support a means for performing a CLI measurement or an uplink transmission, or both, in accordance with the capability, where the CLI measurement occurs during a first resource and the uplink transmission occurs during a second resource that at least partially overlaps in a time domain with the first resource.

In some examples, the resource component 735 may be configured as or otherwise support a means for receiving a resource allocation for a set of multiple resources including the first resource, the set of multiple resources being associated with intra-cell CLI measurements, where the resource allocation is based on the capability including a capability of the UE to support simultaneous intra-cell CLI measurements and uplink transmissions.

In some examples, to support performing the CLI measurement or the uplink transmission, or both, the CLI component 730 may be configured as or otherwise support a means for performing an intra-cell CLI measurement during the first resource and the uplink transmission during the second resource based on the capability.

In some examples, a predetermined timing for performing the intra-cell CLI measurements on the set of multiple resources corresponds to an uplink transmission timing of the UE. In some examples, performing the intra-cell CLI measurement during the first resource is based on the predetermined timing.

In some examples, the timing component 745 may be configured as or otherwise support a means for receiving a second message indicating a timing for performing the intra-cell CLI measurements on the set of multiple resources based on the resource allocation, where performing the intra-cell CLI measurement during the first resource is based on the timing.

In some examples, the resource component 735 may be configured as or otherwise support a means for receiving a resource allocation for a set of multiple resources including the first resource, respective resources of the set of multiple resources being associated with either intra-cell CLI measurements or inter-cell CLI measurements, where the resource allocation is based on the capability. In some examples, the CLI component 730 may be configured as or otherwise support a means for receiving a third message including an indication to perform the intra-cell CLI measurements or the inter-cell CLI measurements, where the indication is based on the capability.

In some examples, to support performing the CLI measurement or the uplink transmission, or both, the CLI component 730 may be configured as or otherwise support a means for performing an intra-cell CLI measurement during the first resource and the uplink transmission during the second resource based on the indication to perform the intra-cell CLI measurement, where the capability includes a capability of the UE to support simultaneous intra-cell CLI measurements and uplink transmissions. In some examples, to support performing the CLI measurement or the uplink transmission, or both, the CLI component 730 may be configured as or otherwise support a means for refraining from performing an inter-cell CLI measurement during a third resource from the set of multiple resources based on the capability and the indication.

In some examples, the resource component 735 may be configured as or otherwise support a means for receiving a resource allocation for a set of multiple resources including the first resource, respective resources of the set of multiple resources being associated with either intra-cell CLI measurements or inter-cell CLI measurements, where the resource allocation is based on the capability. In some examples, the resource component 735 may be configured as or otherwise support a means for receiving a third message including an indication of which resources of the set of multiple resources are associated with the simultaneous uplink transmissions and the CLI measurements or associated with CLI measurements without simultaneous uplink transmissions, where the indication is based on the capability.

In some examples, to support performing the CLI measurement or the uplink transmission, or both, the CLI component 730 may be configured as or otherwise support a means for performing an intra-cell CLI measurement during the first resource and the uplink transmission during the second resource based on the third message including an indication to perform the intra-cell CLI measurement on the first resource, where the capability includes a capability of the UE to support simultaneous intra-cell CLI measurements and uplink transmissions.

In some examples, to support performing the CLI measurement or the uplink transmission, or both, the CLI component 730 may be configured as or otherwise support a means for performing an inter-cell CLI measurement during a third resource of the set of multiple resources based on the third message indicating that the third resource is associated with CLI measurements without simultaneous uplink transmissions. In some examples, to support performing the CLI measurement or the uplink transmission, or both, the uplink transmission component 740 may be configured as or otherwise support a means for refraining from performing the uplink transmission during a fourth resource that at least partially overlaps with the third resource based on the capability and the indication.

In some examples, the resource component 735 may be configured as or otherwise support a means for receiving a resource allocation for a set of multiple resources, the set of multiple resources including a first subset of resources associated with intra-cell CLI measurements and a second subset of resources associated with inter-cell CLI measurements.

In some examples, the first subset and the second subset correspond to different resource groups based on a timing gap between the intra-cell CLI measurements and the inter-cell CLI measurements being greater than a threshold duration.

In some examples, the first subset and the second subset correspond to a same resource group based on a timing gap between the intra-cell CLI measurements and the inter-cell CLI measurements being less than or equal to a threshold duration.

In some examples, the message indicating the capability includes a set of multiple bits, the set of multiple bits indicating a capability of the UE to support intra-cell CLI measurements, a capability of the UE to support inter-cell CLI measurements, a threshold (e.g., maximum) timing difference between the CLI measurements and the uplink transmission, a CLI strength threshold, or any combination thereof.

In some examples, to support performing the CLI measurement or the uplink transmission, or both, the timing component 745 may be configured as or otherwise support a means for determining a timing difference between the first resource and the second resource is greater than the threshold timing difference. In some examples, to support performing the CLI measurement or the uplink transmission, or both, the timing component 745 may be configured as or otherwise support a means for refraining from performing the CLI measurement during the first resource, the second resource, or both, based on the second resource at least partially overlapping in the time domain with the first resource. In some examples, to support performing the CLI measurement or the uplink transmission, or both, the timing component 745 may be configured as or otherwise support a means for performing the uplink transmission during the second resource in accordance with the capability based on the timing difference.

In some examples, the CLI component 730 may be configured as or otherwise support a means for updating a coefficient for filtering CLI based on refraining from performing the CLI measurement during one or more CLI measurement occasions.

In some examples, to support performing the CLI measurement or the uplink transmission, or both, the CLI component 730 may be configured as or otherwise support a means for performing the CLI measurement during at least a portion of the first resource to obtain a CLI strength. In some examples, to support performing the CLI measurement or the uplink transmission, or both, the CLI component 730 may be configured as or otherwise support a means for terminating the CLI measurement for a remaining portion of the first resource based on the CLI strength being below the CLI strength threshold. In some examples, to support performing the CLI measurement or the uplink transmission, or both, the uplink transmission component 740 may be configured as or otherwise support a means for performing the uplink transmission during the second resource in accordance with the capability and based on terminating the CLI measurement for the remaining portion of the first resource.

In some examples, the CLI component 730 may be configured as or otherwise support a means for updating a coefficient for filtering CLI based on terminating the CLI measurement during one or more CLI measurement occasions.

In some examples, to support performing the CLI measurement or the uplink transmission, or both, the CLI component 730 may be configured as or otherwise support a means for performing the CLI measurement during the first resource in accordance with the capability. In some examples, to support performing the CLI measurement or the uplink transmission, or both, the uplink transmission component 740 may be configured as or otherwise support a means for refraining from preforming the uplink transmission during the second resource in accordance with the capability.

In some examples, to support performing the CLI measurement or the uplink transmission, or both, the uplink transmission component 740 may be configured as or otherwise support a means for performing the uplink transmission during the second resource in accordance with the capability. In some examples, to support performing the CLI measurement or the uplink transmission, or both, the CLI component 730 may be configured as or otherwise support a means for refraining from preforming the CLI measurement during the first resource in accordance with the capability.

In some examples, the message indicating the capability is different from another message including an indication of a capability of the UE to support the full-duplex communication mode.

In some examples, the message indicating the capability further includes an indication of a capability of the UE to support the full-duplex communication mode.

In some examples, the capability of the UE to support the simultaneous uplink transmissions and the CLI measurements is based on the UE supporting the full-duplex communication mode.

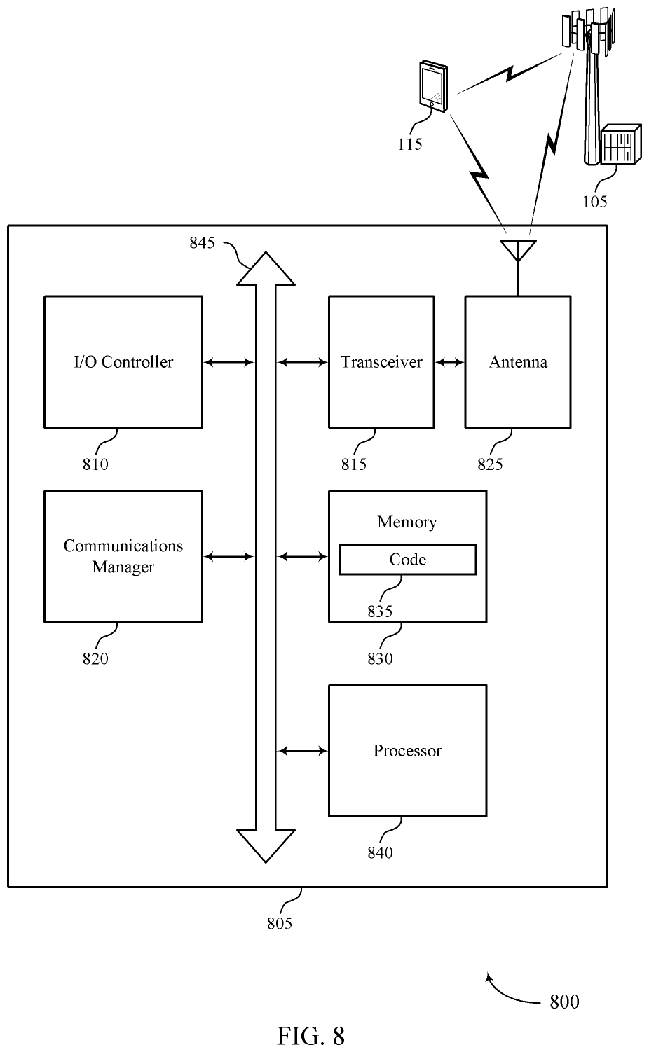

FIG. 8 shows a diagram of a system 800 including a device 805 that supports performing CLI measurements in a full-duplex communication mode in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting performing CLI measurements in a full-duplex communication mode). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting a message indicating a capability of the UE to support simultaneous uplink transmissions and CLI measurements on respective resources while operating in a full-duplex communication mode. The communications manager 820 may be configured as or otherwise support a means for performing a CLI measurement or an uplink transmission, or both, in accordance with the capability, where the CLI measurement occurs during a first resource and the uplink transmission occurs during a second resource that at least partially overlaps in a time domain with the first resource.

By including or configuring the communications manager 820 in accordance with examples as described herein, the device 805 may support techniques for a UE to indicate a capability to support a CLI measurement and uplink transmission in a full-duplex communication mode to a network entity, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of performing CLI measurements in a full-duplex communication mode as described herein, or the processor 840 and the memory 830 may be otherwise configured to perform or support such operations.

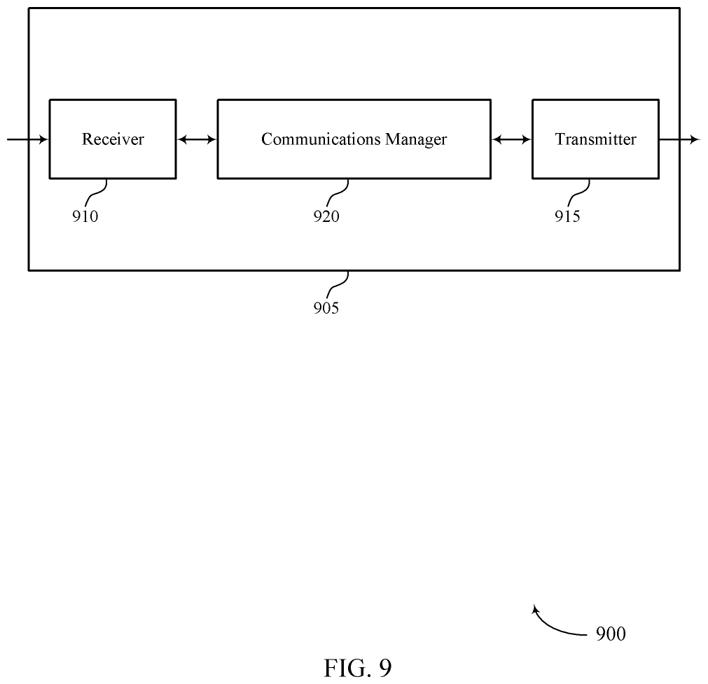

FIG. 9 shows a block diagram 900 of a device 905 that supports performing CLI measurements in a full-duplex communication mode in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of performing CLI measurements in a full-duplex communication mode as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for receiving a message indicating a capability of a UE to support simultaneous uplink transmissions and CLI measurements on respective resources while operating in a full-duplex communication mode. The communications manager 920 may be configured as or otherwise support a means for receiving an uplink transmission during a first resource that at least partially overlaps in a time domain with a second resource configured for a CLI measurement in accordance with the capability.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a UE to indicate a capability to support a CLI measurement and uplink transmission in a full-duplex communication mode to a network entity, which may provide for reduced processing, reduced power consumption, more efficient utilization of communication resources, and the like.

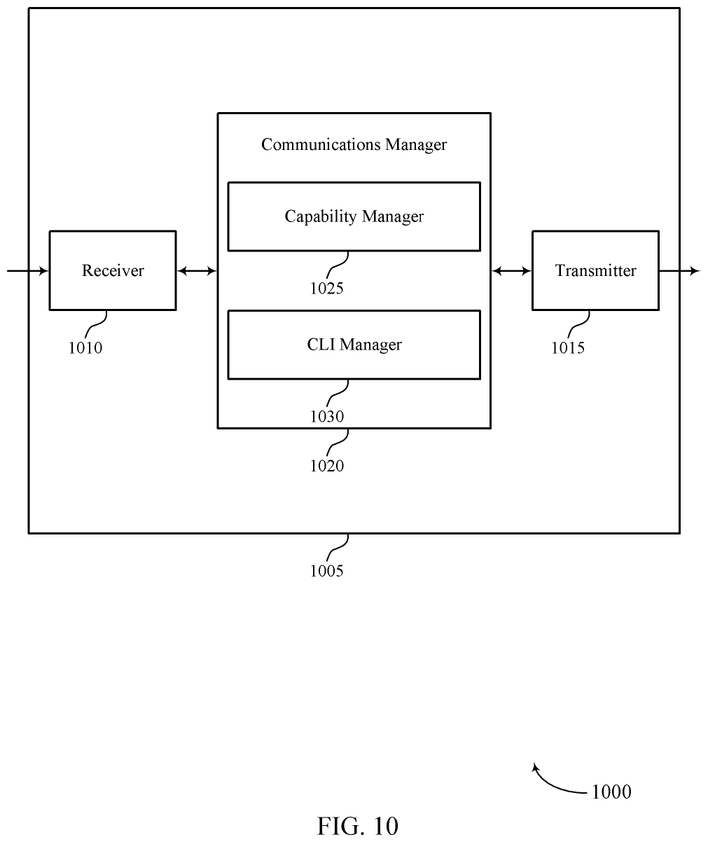

FIG. 10 shows a block diagram 1000 of a device 1005 that supports performing CLI measurements in a full-duplex communication mode in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of performing CLI measurements in a full-duplex communication mode as described herein. For example, the communications manager 1020 may include a capability manager 1025 a CLI manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The capability manager 1025 may be configured as or otherwise support a means for receiving a message indicating a capability of a UE to support simultaneous uplink transmissions and CLI measurements on respective resources while operating in a full-duplex communication mode. The CLI manager 1030 may be configured as or otherwise support a means for receiving an uplink transmission during a first resource that at least partially overlaps in a time domain with a second resource configured for a CLI measurement in accordance with the capability.

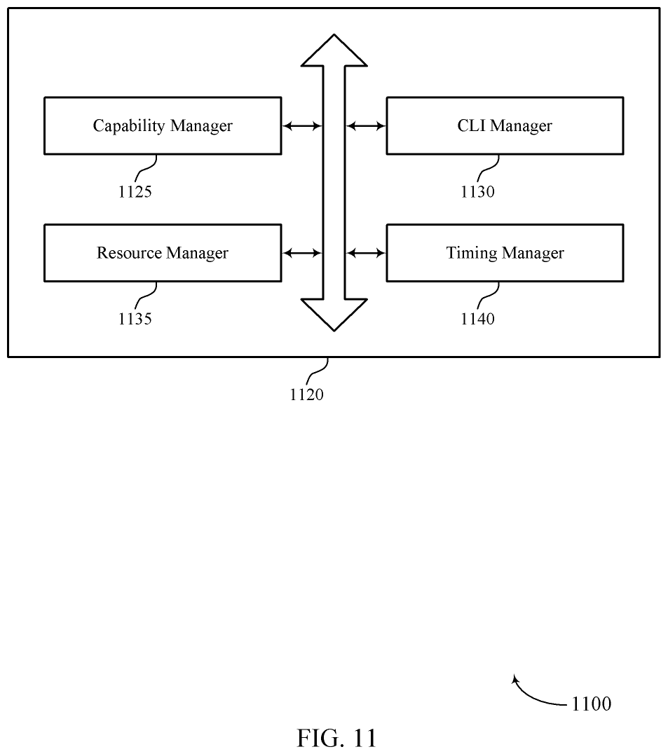

FIG. 11 shows a block diagram 1100 of a communications manager 1120 that supports performing CLI measurements in a full-duplex communication mode in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of performing CLI measurements in a full-duplex communication mode as described herein. For example, the communications manager 1120 may include a capability manager 1125, a CLI manager 1130, a resource manager 1135, a timing manager 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The capability manager 1125 may be configured as or otherwise support a means for receiving a message indicating a capability of a UE to support simultaneous uplink transmissions and CLI measurements on respective resources while operating in a full-duplex communication mode. The CLI manager 1130 may be configured as or otherwise support a means for receiving an uplink transmission during a first resource that at least partially overlaps in a time domain with a second resource configured for a CLI measurement in accordance with the capability.

In some examples, the resource manager 1135 may be configured as or otherwise support a means for transmitting a resource allocation for a set of multiple resources including the first resource, the set of multiple resources being associated with intra-cell CLI measurements, where the resource allocation is based on the capability including a capability of the UE to support simultaneous intra-cell CLI measurements and uplink transmissions.

In some examples, a predetermined timing for performing the intra-cell CLI measurements on the set of multiple resources corresponds to an uplink transmission timing of the UE.

In some examples, the timing manager 1140 may be configured as or otherwise support a means for transmitting a second message indicating a timing for performing the intra-cell CLI measurements on the set of multiple resources based on the resource allocation.

In some examples, the resource manager 1135 may be configured as or otherwise support a means for transmitting a resource allocation for a set of multiple resources including the first resource, respective resources of the set of multiple resources being associated with either intra-cell CLI measurements or inter-cell CLI measurements, where the resource allocation is based on the capability including a capability of the UE to support simultaneous intra-cell CLI measurements and uplink transmissions. In some examples, the CLI manager 1130 may be configured as or otherwise support a means for transmitting a third message including an indication to perform the intra-cell CLI measurements or the inter-cell CLI measurements, where the indication is based on the capability.

In some examples, the resource manager 1135 may be configured as or otherwise support a means for transmitting a resource allocation for a set of multiple resources including the first resource, respective resources of the set of multiple resources being associated with either intra-cell CLI measurements or inter-cell CLI measurements, where the resource allocation is based on the capability. In some examples, the resource manager 1135 may be configured as or otherwise support a means for transmitting a third message including an indication of which resources of the set of multiple resources are associated with the simultaneous uplink transmissions and the CLI measurements or associated with CLI measurements without simultaneous uplink transmissions, where the indication is based on the capability.

In some examples, the resource manager 1135 may be configured as or otherwise support a means for transmitting a resource allocation for a set of multiple resources, the set of multiple resources including a first subset of resources associated with intra-cell CLI measurements and a second subset of resources associated with inter-cell CLI measurements.

In some examples, the first subset and the second subset correspond to different resource groups based on a timing gap between the intra-cell CLI measurements and the inter-cell CLI measurements being greater than a threshold duration.

In some examples, the first subset and the second subset correspond to a same resource group based on a timing gap between the intra-cell CLI measurements and the inter-cell CLI measurements being less than or equal to a threshold duration.

In some examples, the message indicating the capability includes a set of multiple bits, the set of multiple bits indicating a capability of the UE to support intra-cell CLI measurements, a capability of the UE to support inter-cell CLI measurements, a threshold (e.g., maximum) timing difference between the CLI measurements and the uplink transmission, a CLI strength threshold, or any combination thereof.

In some examples, the capability includes an inability of the UE to support the simultaneous uplink transmissions and the CLI measurements.

In some examples, the message indicating the capability is different from another message including an indication of a capability of the UE to support the full-duplex communication mode.

In some examples, the message indicating the capability further includes an indication of a capability of the UE to support the full-duplex communication mode.

In some examples, the capability of the UE to support the simultaneous uplink transmissions and the CLI measurements is based on the UE supporting the full-duplex communication mode.

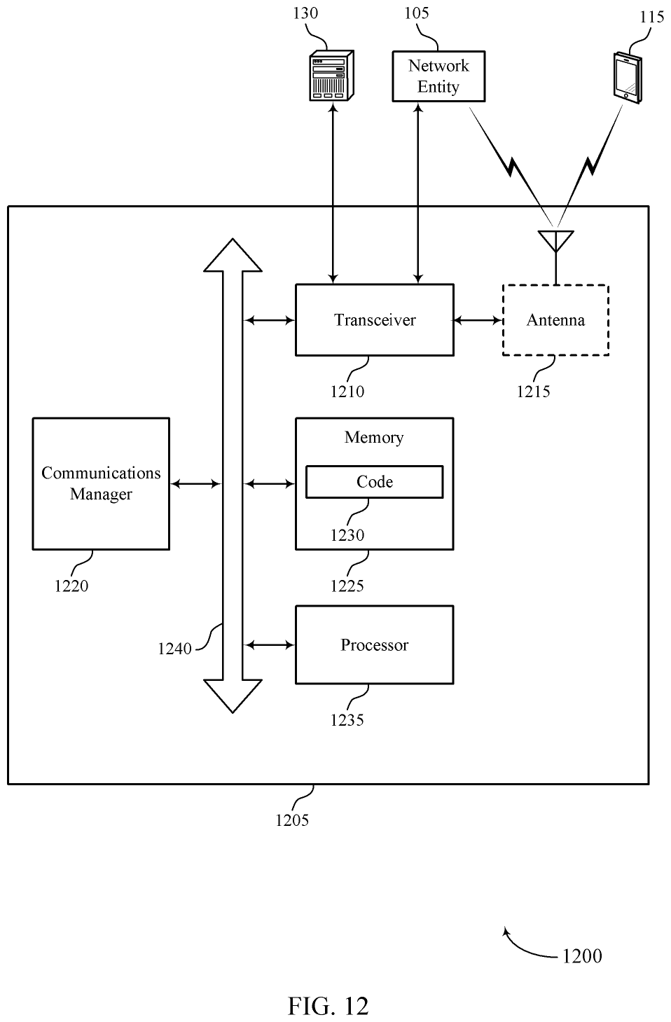

FIG. 12 shows a diagram of a system 1200 including a device 1205 that supports performing CLI measurements in a full-duplex communication mode in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting performing CLI measurements in a full-duplex communication mode). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for receiving a message indicating a capability of a UE to support simultaneous uplink transmissions and CLI measurements on respective resources while operating in a full-duplex communication mode. The communications manager 1220 may be configured as or otherwise support a means for receiving an uplink transmission during a first resource that at least partially overlaps in a time domain with a second resource configured for a CLI measurement in accordance with the capability.

By including or configuring the communications manager 1220 in accordance with examples as described herein, the device 1205 may support techniques for a UE to indicate a capability to support a CLI measurement and uplink transmission in a full-duplex communication mode to a network entity, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of performing CLI measurements in a full-duplex communication mode as described herein, or the processor 1235 and the memory 1225 may be otherwise configured to perform or support such operations.

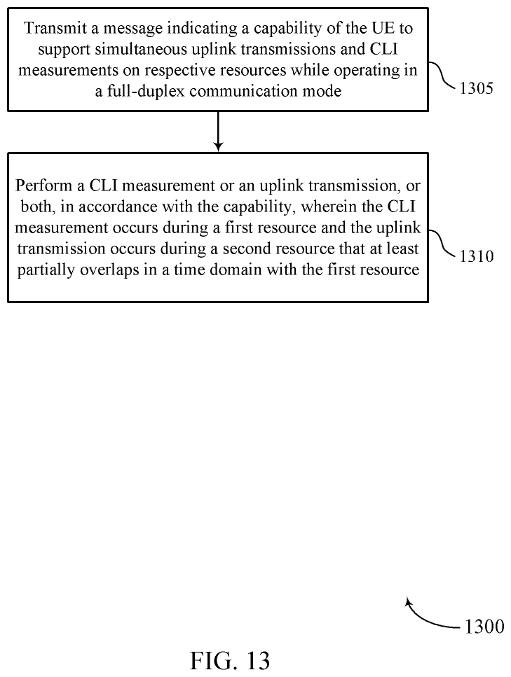

FIG. 13 shows a flowchart illustrating a method 1300 that supports performing CLI measurements in a full-duplex communication mode in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a message indicating a capability of the UE to support simultaneous uplink transmissions and CLI measurements on respective resources while operating in a full-duplex communication mode. The operations of 1305 may be performed in accordance with examples as disclosed herein. In some examples, aspects of the operations of 1305 may be performed by a capability component 725 as described with reference to FIG. 7.

At 1310, the method may include performing a CLI measurement or an uplink transmission, or both, in accordance with the capability, where the CLI measurement occurs during a first resource and the uplink transmission occurs during a second resource that at least partially overlaps in a time domain with the first resource. The operations of 1310 may be performed in accordance with examples as disclosed herein. In some examples, aspects of the operations of 1310 may be performed by a CLI component 730 as described with reference to FIG. 7.

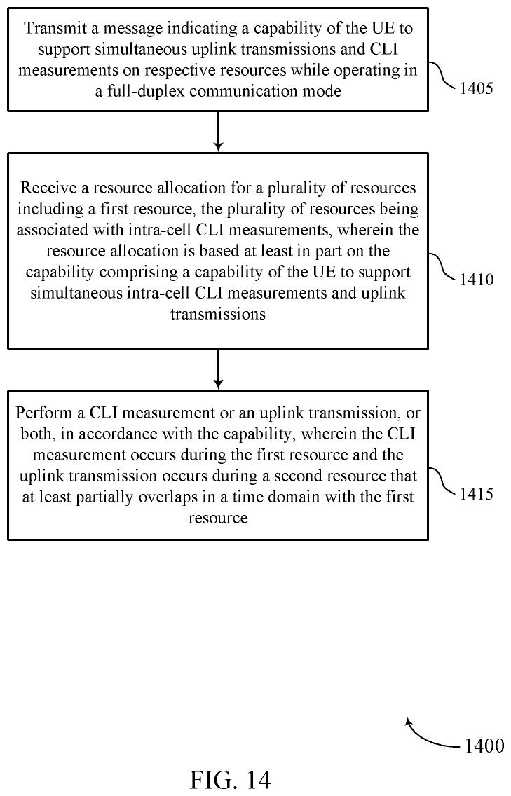

FIG. 14 shows a flowchart illustrating a method 1400 that supports performing CLI measurements in a full-duplex communication mode in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a message indicating a capability of the UE to support simultaneous uplink transmissions and CLI measurements on respective resources while operating in a full-duplex communication mode. The operations of 1405 may be performed in accordance with examples as disclosed herein. In some examples, aspects of the operations of 1405 may be performed by a capability component 725 as described with reference to FIG. 7.

At 1410, the method may include receiving a resource allocation for a set of multiple resources including a first resource, the set of multiple resources being associated with intra-cell CLI measurements, where the resource allocation is based on the capability including a capability of the UE to support simultaneous intra-cell CLI measurements and uplink transmissions. The operations of 1410 may be performed in accordance with examples as disclosed herein. In some examples, aspects of the operations of 1410 may be performed by a resource component 735 as described with reference to FIG. 7.

At 1415, the method may include performing a CLI measurement or an uplink transmission, or both, in accordance with the capability, where the CLI measurement occurs during the first resource and the uplink transmission occurs during a second resource that at least partially overlaps in a time domain with the first resource. The operations of 1415 may be performed in accordance with examples as disclosed herein. In some examples, aspects of the operations of 1415 may be performed by a CLI component 730 as described with reference to FIG. 7.

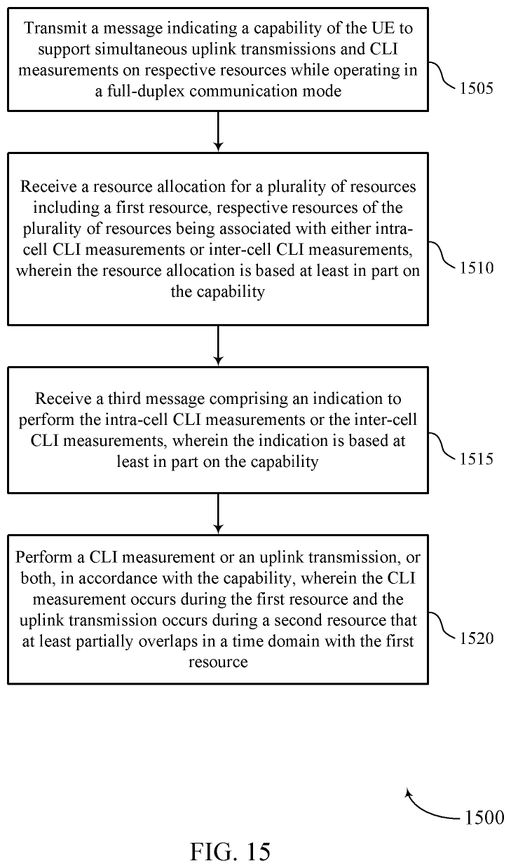

FIG. 15 shows a flowchart illustrating a method 1500 that supports performing CLI measurements in a full-duplex communication mode in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a message indicating a capability of the UE to support simultaneous uplink transmissions and CLI measurements on respective resources while operating in a full-duplex communication mode. The operations of 1505 may be performed in accordance with examples as disclosed herein. In some examples, aspects of the operations of 1505 may be performed by a capability component 725 as described with reference to FIG. 7.

At 1510, the method may include receiving a resource allocation for a set of multiple resources including a first resource, respective resources of the set of multiple resources being associated with either intra-cell CLI measurements or inter-cell CLI measurements, where the resource allocation is based on the capability. The operations of 1510 may be performed in accordance with examples as disclosed herein. In some examples, aspects of the operations of 1510 may be performed by a resource component 735 as described with reference to FIG. 7.

At 1515, the method may include receiving a third message including an indication to perform the intra-cell CLI measurements or the inter-cell CLI measurements, where the indication is based on the capability. The operations of 1515 may be performed in accordance with examples as disclosed herein. In some examples, aspects of the operations of 1515 may be performed by a CLI component 730 as described with reference to FIG. 7.

At 1520, the method may include performing a CLI measurement or an uplink transmission, or both, in accordance with the capability, where the CLI measurement occurs during the first resource and the uplink transmission occurs during a second resource that at least partially overlaps in a time domain with the first resource. The operations of 1520 may be performed in accordance with examples as disclosed herein. In some examples, aspects of the operations of 1520 may be performed by a CLI component 730 as described with reference to FIG. 7.

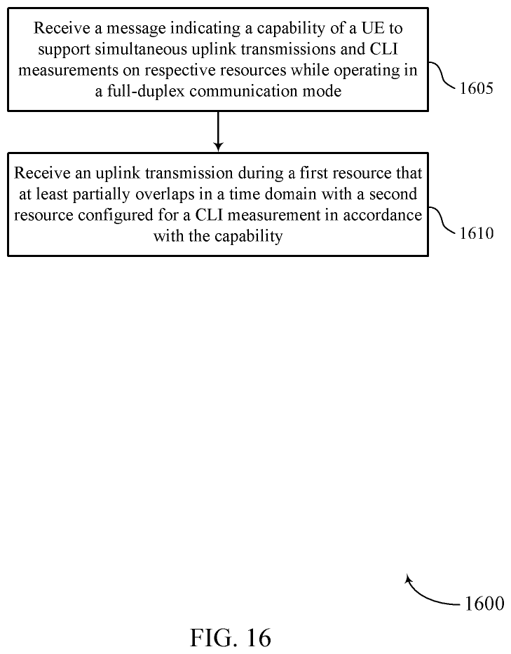

FIG. 16 shows a flowchart illustrating a method 1600 that supports performing CLI measurements in a full-duplex communication mode in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a message indicating a capability of a UE to support simultaneous uplink transmissions and CLI measurements on respective resources while operating in a full-duplex communication mode. The operations of 1605 may be performed in accordance with examples as disclosed herein. In some examples, aspects of the operations of 1605 may be performed by a capability manager 1125 as described with reference to FIG. 11.

At 1610, the method may include receiving an uplink transmission during a first resource that at least partially overlaps in a time domain with a second resource configured for a CLI measurement in accordance with the capability. The operations of 1610 may be performed in accordance with examples as disclosed herein. In some examples, aspects of the operations of 1610 may be performed by a CLI manager 1130 as described with reference to FIG. 11.

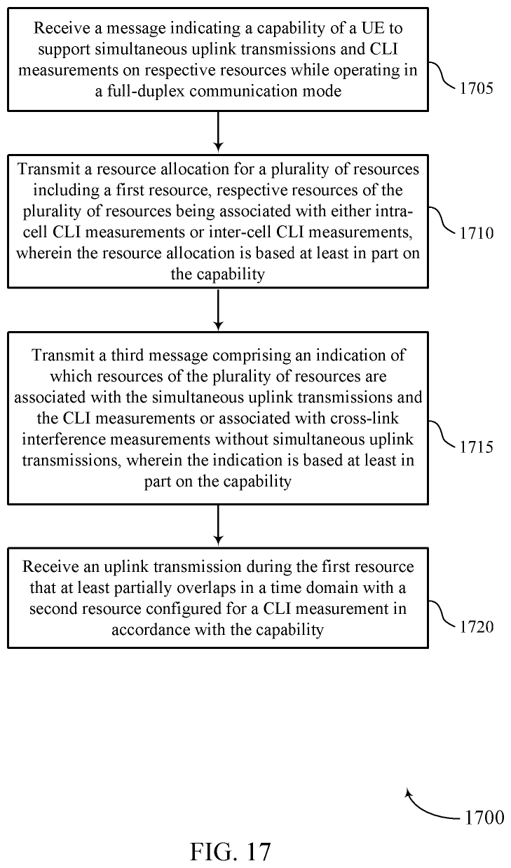

FIG. 17 shows a flowchart illustrating a method 1700 that supports performing CLI measurements in a full-duplex communication mode in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving a message indicating a capability of a UE to support simultaneous uplink transmissions and CLI measurements on respective resources while operating in a full-duplex communication mode. The operations of 1705 may be performed in accordance with examples as disclosed herein. In some examples, aspects of the operations of 1705 may be performed by a capability manager 1125 as described with reference to FIG. 11.

At 1710, the method may include transmitting a resource allocation for a set of multiple resources including a first resource, respective resources of the set of multiple resources being associated with either intra-cell CLI measurements or inter-cell CLI measurements, where the resource allocation is based on the capability. The operations of 1710 may be performed in accordance with examples as disclosed herein. In some examples, aspects of the operations of 1710 may be performed by a resource manager 1135 as described with reference to FIG. 11.

At 1715, the method may include transmitting a third message including an indication of which resources of the set of multiple resources are associated with the simultaneous uplink transmissions and the CLI measurements or associated with CLI measurements without simultaneous uplink transmissions, where the indication is based on the capability. The operations of 1715 may be performed in accordance with examples as disclosed herein. In some examples, aspects of the operations of 1715 may be performed by a resource manager 1135 as described with reference to FIG. 11.

At 1720, the method may include receiving an uplink transmission during the first resource that at least partially overlaps in a time domain with a second resource configured for a CLI measurement in accordance with the capability. The operations of 1720 may be performed in accordance with examples as disclosed herein. In some examples, aspects of the operations of 1720 may be performed by a CLI manager 1130 as described with reference to FIG. 11.

The following provides an overview of aspects of the present disclosure:

Aspect 1: A method for wireless communication at a UE, comprising: transmitting a message indicating a capability of the UE to support simultaneous uplink transmissions and cross-link interference measurements on respective resources while operating in a full-duplex communication mode; and performing a cross-link interference measurement or an uplink transmission, or both, in accordance with the capability, wherein the cross-link interference measurement occurs during a first resource and the uplink transmission occurs during a second resource that at least partially overlaps in a time domain with the first resource.

Aspect 2: The method of aspect 1, further comprising: receiving a resource allocation for a plurality of resources including the first resource, the plurality of resources being associated with intra-cell cross-link interference measurements, wherein the resource allocation is based at least in part on the capability comprising a capability of the UE to support simultaneous intra-cell cross-link interference measurements and uplink transmissions.

Aspect 3: The method of aspect 2, wherein performing the cross-link interference measurement or the uplink transmission, or both, comprises: performing an intra-cell cross-link interference measurement during the first resource and the uplink transmission during the second resource based at least in part on the capability.

Aspect 4: The method of aspect 3, wherein a predetermined timing for performing the intra-cell cross-link interference measurements on the plurality of resources corresponds to an uplink transmission timing of the UE, performing the intra-cell cross-link interference measurement during the first resource is based at least in part on the predetermined timing.

Aspect 5: The method of aspect 3, further comprising: receiving a second message indicating a timing for performing the intra-cell cross-link interference measurements on the plurality of resources based at least in part on the resource allocation, wherein performing the intra-cell cross-link interference measurement during the first resource is based at least in part on the timing.

Aspect 6: The method of any of aspects 1 through 5, further comprising: receiving a resource allocation for a plurality of resources including the first resource, respective resources of the plurality of resources being associated with either intra-cell cross-link interference measurements or inter-cell cross-link interference measurements, wherein the resource allocation is based at least in part on the capability; and receiving a third message comprising an indication to perform the intra-cell cross-link interference measurements or the inter-cell cross-link interference measurements, wherein the indication is based at least in part on the capability.

Aspect 7: The method of aspect 6, wherein performing the cross-link interference measurement or the uplink transmission, or both, comprises: performing an intra-cell cross-link interference measurement during the first resource and the uplink transmission during the second resource based at least in part on the indication to perform the intra-cell cross-link interference measurement, wherein the capability comprises a capability of the UE to support simultaneous intra-cell cross-link interference measurements and uplink transmissions; and refraining from performing an inter-cell cross-link interference measurement during a third resource from the plurality of resources based at least in part on the capability and the indication.

Aspect 8: The method of any of aspects 1 through 5, further comprising: receiving a resource allocation for a plurality of resources including the first resource, respective resources of the plurality of resources being associated with either intra-cell cross-link interference measurements or inter-cell cross-link interference measurements, wherein the resource allocation is based at least in part on the capability; and receiving a third message comprising an indication of which resources of the plurality of resources are associated with the simultaneous uplink transmissions and the cross-link interference measurements or associated with cross-link interference measurements without simultaneous uplink transmissions, wherein the indication is based at least in part on the capability.

Aspect 9: The method of aspect 8, wherein performing the cross-link interference measurement or the uplink transmission, or both, comprises: performing an intra-cell cross-link interference measurement during the first resource and the uplink transmission during the second resource based at least in part on the third message comprising an indication to perform the intra-cell cross-link interference measurement on the first resource, wherein the capability comprises a capability of the UE to support simultaneous intra-cell cross-link interference measurements and uplink transmissions.

Aspect 10: The method of aspect 9, wherein performing the cross-link interference measurement or the uplink transmission, or both, comprises: performing an inter-cell cross-link interference measurement during a third resource of the plurality of resources based at least in part on the third message indicating that the third resource is associated with cross-link interference measurements without simultaneous uplink transmissions; and refraining from performing the uplink transmission during a fourth resource that at least partially overlaps with the third resource based at least in part on the capability and the indication.

Aspect 11: The method of any of aspects 1 through 10, further comprising: receiving a resource allocation for a plurality of resources, the plurality of resources comprising a first subset of resources associated with intra-cell cross-link interference measurements and a second subset of resources associated with inter-cell cross-link interference measurements.

Aspect 12: The method of aspect 11, wherein the first subset and the second subset correspond to different resource groups based at least in part on a timing gap between the intra-cell cross-link interference measurements and the inter-cell cross-link interference measurements being greater than a threshold duration.

Aspect 13: The method of aspect 11, wherein the first subset and the second subset correspond to a same resource group based at least in part on a timing gap between the intra-cell cross-link interference measurements and the inter-cell cross-link interference measurements being less than or equal to a threshold duration.

Aspect 14: The method of any of aspects 1 through 13, wherein the message indicating the capability comprises a plurality of bits, the plurality of bits indicating a capability of the UE to support intra-cell cross-link interference measurements, a capability of the UE to support inter-cell cross-link interference measurements, a maximum timing difference between the cross-link interference measurements and the uplink transmission, a cross-link interference strength threshold, or any combination thereof.

Aspect 15: The method of aspect 14, wherein performing the cross-link interference measurement or the uplink transmission, or both, comprises: determining a timing difference between the first resource and the second resource is greater than the maximum timing difference; refraining from performing the cross-link interference measurement during the first resource, the second resource, or both, based at least in part on the second resource at least partially overlapping in the time domain with the first resource; and performing the uplink transmission during the second resource in accordance with the capability based at least in part on the timing difference.

Aspect 16: The method of aspect 15, further comprising: updating a coefficient for filtering cross-link interference based at least in part on refraining from performing the cross-link interference measurement during one or more cross-link interference measurement occasions.

Aspect 17: The method of any of aspects 14 through 16, wherein performing the cross-link interference measurement or the uplink transmission, or both, comprises: performing the cross-link interference measurement during at least a portion of the first resource to obtain a cross-link interference strength; terminating the cross-link interference measurement for a remaining portion of the first resource based at least in part on the cross-link interference strength being below the cross-link interference strength threshold; and performing the uplink transmission during the second resource in accordance with the capability and based at least in part on terminating the cross-link interference measurement for the remaining portion of the first resource.

Aspect 18: The method of aspect 17, further comprising: updating a coefficient for filtering cross-link interference based at least in part on terminating the cross-link interference measurement during one or more cross-link interference measurement occasions.

Aspect 19: The method of any of aspects 1 through 18, wherein the capability comprises an inability to support the simultaneous uplink transmissions and the cross-link interference measurements, and wherein performing the cross-link interference measurement or the uplink transmission, or both, comprises: performing the cross-link interference measurement during the first resource in accordance with the capability; and refraining from preforming the uplink transmission during the second resource in accordance with the capability.

Aspect 20: The method of any of aspects 1 through 18, wherein the message indicates the UE does not have the capability to support the simultaneous uplink transmissions and the cross-link interference measurements, and wherein performing the cross-link interference measurement or the uplink transmission, or both, comprises: performing the uplink transmission during the second resource in accordance with the capability; and refraining from preforming the cross-link interference measurement during the first resource in accordance with the capability.

Aspect 21: The method of any of aspects 1 through 20, wherein the message indicating the capability is different from another message comprising an indication of a capability of the UE to support the full-duplex communication mode.

Aspect 22: The method of any of aspects 1 through 20, wherein the message indicating the capability further includes an indication of a capability of the UE to support the full-duplex communication mode.

Aspect 23: The method of any of aspects 1 through 20, wherein the capability of the UE to support the simultaneous uplink transmissions and the cross-link interference measurements is based at least in part on the UE supporting the full-duplex communication mode.

Aspect 24: A method for wireless communication at a network entity, comprising: receiving a message indicating a capability of a UE to support simultaneous uplink transmissions and cross-link interference measurements on respective resources while operating in a full-duplex communication mode; and receiving an uplink transmission during a first resource that at least partially overlaps in a time domain with a second resource configured for a cross-link interference measurement in accordance with the capability.

Aspect 25: The method of aspect 24, further comprising: transmitting a resource allocation for a plurality of resources including the first resource, the plurality of resources being associated with intra-cell cross-link interference measurements, wherein the resource allocation is based at least in part on the capability comprising a capability of the UE to support simultaneous intra-cell cross-link interference measurements and uplink transmissions.

Aspect 26: The method of aspect 25, wherein a predetermined timing for performing the intra-cell cross-link interference measurements on the plurality of resources corresponds to an uplink transmission timing of the UE.

Aspect 27: The method of aspect 25, further comprising: transmitting a second message indicating a timing for performing the intra-cell cross-link interference measurements on the plurality of resources based at least in part on the resource allocation.

Aspect 28: The method of any of aspects 24 through 27, further comprising: transmitting a resource allocation for a plurality of resources including the first resource, respective resources of the plurality of resources being associated with either intra-cell cross-link interference measurements or inter-cell cross-link interference measurements, wherein the resource allocation is based at least in part on the capability comprising a capability of the UE to support simultaneous intra-cell cross-link interference measurements and uplink transmissions; and transmitting a third message comprising an indication to perform the intra-cell cross-link interference measurements or the inter-cell cross-link interference measurements, wherein the indication is based at least in part on the capability.

Aspect 29: The method of any of aspects 24 through 28, further comprising: transmitting a resource allocation for a plurality of resources including the first resource, respective resources of the plurality of resources being associated with either intra-cell cross-link interference measurements or inter-cell cross-link interference measurements, wherein the resource allocation is based at least in part on the capability; and transmitting a third message comprising an indication of which resources of the plurality of resources are associated with the simultaneous uplink transmissions and the cross-link interference measurements or associated with cross-link interference measurements without simultaneous uplink transmissions, wherein the indication is based at least in part on the capability.

Aspect 30: The method of any of aspects 24 through 29, further comprising: transmitting a resource allocation for a plurality of resources, the plurality of resources comprising a first subset of resources associated with intra-cell cross-link interference measurements and a second subset of resources associated with inter-cell cross-link interference measurements.

Aspect 31: The method of aspect 30, wherein the first subset and the second subset correspond to different resource groups based at least in part on a timing gap between the intra-cell cross-link interference measurements and the inter-cell cross-link interference measurements being greater than a threshold duration.

Aspect 32: The method of aspect 30, wherein the first subset and the second subset correspond to a same resource group based at least in part on a timing gap between the intra-cell cross-link interference measurements and the inter-cell cross-link interference measurements being less than or equal to a threshold duration.

Aspect 33: The method of any of aspects 24 through 32, wherein the message indicating the capability comprises a plurality of bits, the plurality of bits indicating a capability of the UE to support intra-cell cross-link interference measurements, a capability of the UE to support inter-cell cross-link interference measurements, a maximum timing difference between the cross-link interference measurements and the uplink transmission, a cross-link interference strength threshold, or any combination thereof.

Aspect 34: The method of any of aspects 24 through 33, wherein the capability comprises an inability of the UE to support the simultaneous uplink transmissions and the cross-link interference measurements.

Aspect 35: The method of any of aspects 24 through 34, wherein the message indicating the capability is different from another message comprising an indication of a capability of the UE to support the full-duplex communication mode.

Aspect 36: The method of any of aspects 24 through 34, wherein the message indicating the capability further includes an indication of a capability of the UE to support the full-duplex communication mode.

Aspect 37: The method of any of aspects 24 through 34, wherein the capability of the UE to support the simultaneous uplink transmissions and the cross-link interference measurements is based at least in part on the UE supporting the full-duplex communication mode.

Aspect 38: An apparatus for wireless communication at a UE, comprising a processor; memory coupled with the processor; and instructions stored in the memory and executable by the processor to cause the apparatus to perform a method of any of aspects 1 through 23.

Aspect 39: An apparatus for wireless communication at a UE, comprising at least one means for performing a method of any of aspects 1 through 23.

Aspect 40: A non-transitory computer-readable medium storing code for wireless communication at a UE, the code comprising instructions executable by a processor to perform a method of any of aspects 1 through 23.

Aspect 41: An apparatus for wireless communication at a network entity, comprising a processor; memory coupled with the processor; and instructions stored in the memory and executable by the processor to cause the apparatus to perform a method of any of aspects 24 through 37.

Aspect 42: An apparatus for wireless communication at a network entity, comprising at least one means for performing a method of any of aspects 24 through 37.

Aspect 43: A non-transitory computer-readable medium storing code for wireless communication at a network entity, the code comprising instructions executable by a processor to perform a method of any of aspects 24 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting a message indicating a capability of the UE to support simultaneous uplink transmissions and cross-link interference measurements on respective resources while operating in a full-duplex communication mode; and
performing a cross-link interference measurement or an uplink transmission, or both, in accordance with the capability, wherein the cross-link interference measurement occurs during a first resource and the uplink transmission occurs during a second resource that at least partially overlaps in a time domain with the first resource.

2. The method of claim 1, further comprising:
receiving a resource allocation for a plurality of resources including the first resource, the plurality of resources being associated with intra-cell cross-link interference measurements, wherein the resource allocation is based at least in part on the capability comprising a capability of the UE to support simultaneous intra-cell cross-link interference measurements and uplink transmissions.

3. The method of claim 2, wherein performing the cross-link interference measurement or the uplink transmission, or both, comprises:
performing an intra-cell cross-link interference measurement during the first resource and the uplink transmission during the second resource based at least in part on the capability.

4. The method of claim 3, wherein a predetermined timing for performing the intra-cell cross-link interference measurements on the plurality of resources corresponds to an uplink transmission timing of the UE and performing the intra-cell cross-link interference measurement during the first resource is based at least in part on the predetermined timing.

5. The method of claim 3, further comprising:
receiving a second message indicating a timing for performing the intra-cell cross-link interference measurements on the plurality of resources based at least in part on the resource allocation, wherein performing the intra-cell cross-link interference measurement during the first resource is based at least in part on the timing.

6. The method of claim 1, further comprising:
receiving a resource allocation for a plurality of resources including the first resource, respective resources of the plurality of resources being associated with either intra-cell cross-link interference measurements or inter-cell cross-link interference measurements, wherein the resource allocation is based at least in part on the capability; and
receiving a third message comprising an indication to perform the intra-cell cross-link interference measurements or the inter-cell cross-link interference measurements, wherein the indication is based at least in part on the capability.

7. The method of claim 6, wherein performing the cross-link interference measurement or the uplink transmission, or both, comprises:
performing an intra-cell cross-link interference measurement during the first resource and the uplink transmission during the second resource based at least in part on the indication to perform the intra-cell cross-link interference measurement, wherein the capability comprises a capability of the UE to support simultaneous intra-cell cross-link interference measurements and uplink transmissions; and
refraining from performing an inter-cell cross-link interference measurement during a third resource from the plurality of resources based at least in part on the capability and the indication.

8. The method of claim 1, further comprising:
receiving a resource allocation for a plurality of resources including the first resource, respective resources of the plurality of resources being associated with either intra-cell cross-link interference measurements or inter-cell cross-link interference measurements, wherein the resource allocation is based at least in part on the capability; and
receiving a third message comprising an indication of which resources of the plurality of resources are associated with the simultaneous uplink transmissions and the cross-link interference measurements or associated with cross-link interference measurements without simultaneous uplink transmissions, wherein the indication is based at least in part on the capability.

9. The method of claim 8, wherein performing the cross-link interference measurement or the uplink transmission, or both, comprises:
performing an intra-cell cross-link interference measurement during the first resource and the uplink transmission during the second resource based at least in part on the third message comprising an indication to perform the intra-cell cross-link interference measurement on the first resource, wherein the capability comprises a capability of the UE to support simultaneous intra-cell cross-link interference measurements and uplink transmissions.

10. The method of claim 9, wherein performing the cross-link interference measurement or the uplink transmission, or both, comprises:
performing an inter-cell cross-link interference measurement during a third resource of the plurality of resources based at least in part on the third message indicating that the third resource is associated with cross-link interference measurements without simultaneous uplink transmissions; and
refraining from performing the uplink transmission during a fourth resource that at least partially overlaps with the third resource based at least in part on the capability and the indication.

11. The method of claim 1, further comprising:
receiving a resource allocation for a plurality of resources, the plurality of resources comprising a first subset of resources associated with intra-cell cross-link interference measurements and a second subset of resources associated with inter-cell cross-link interference measurements.

12. The method of claim 11, wherein the first subset and the second subset correspond to different resource groups based at least in part on a timing gap between the intra-cell cross-link interference measurements and the inter-cell cross-link interference measurements being greater than a threshold duration.

13. The method of claim 11, wherein the first subset and the second subset correspond to a same resource group based at least in part on a timing gap between the intra-cell cross-link interference measurements and the inter-cell cross-link interference measurements being less than or equal to a threshold duration.

14. The method of claim 1, wherein the message indicating the capability comprises a plurality of bits, the plurality of bits indicating a capability of the UE to support intra-cell cross-link interference measurements, a capability of the UE to support inter-cell cross-link interference measurements, a threshold timing difference between the cross-link interference measurements and the uplink transmission, a cross-link interference strength threshold, or any combination thereof.

15. The method of claim 14, wherein performing the cross-link interference measurement or the uplink transmission, or both, comprises:
determining a timing difference between the first resource and the second resource is greater than the threshold timing difference;
refraining from performing the cross-link interference measurement during the first resource, the second resource, or both, based at least in part on the second resource at least partially overlapping in the time domain with the first resource; and
performing the uplink transmission during the second resource in accordance with the capability based at least in part on the timing difference.

16. The method of claim 15, further comprising:
updating a coefficient for filtering cross-link interference based at least in part on refraining from performing the cross-link interference measurement during one or more cross-link interference measurement occasions.

17. The method of claim 14, wherein performing the cross-link interference measurement or the uplink transmission, or both, comprises:
performing the cross-link interference measurement during at least a portion of the first resource to obtain a cross-link interference strength;
terminating the cross-link interference measurement for a remaining portion of the first resource based at least in part on the cross-link interference strength being below the cross-link interference strength threshold; and
performing the uplink transmission during the second resource in accordance with the capability and based at least in part on terminating the cross-link interference measurement for the remaining portion of the first resource.

18. The method of claim 17, further comprising:
updating a coefficient for filtering cross-link interference based at least in part on terminating the cross-link interference measurement during one or more cross-link interference measurement occasions.

19. The method of claim 1, wherein the capability comprises an inability to support the simultaneous uplink transmissions and the cross-link interference measurements, and wherein performing the cross-link interference measurement or the uplink transmission, or both, comprises:
performing the cross-link interference measurement during the first resource in accordance with the capability; and
refraining from preforming the uplink transmission during the second resource in accordance with the capability.

20. The method of claim 1, wherein the message indicates the UE does not have the capability to support the simultaneous uplink transmissions and the cross-link interference measurements, and wherein performing the cross-link interference measurement or the uplink transmission, or both, comprises:
performing the uplink transmission during the second resource in accordance with the capability; and
refraining from preforming the cross-link interference measurement during the first resource in accordance with the capability.

21. The method of claim 1, wherein the message indicating the capability is different from another message comprising an indication of a capability of the UE to support the full-duplex communication mode.

22. The method of claim 1, wherein the message indicating the capability further includes an indication of a capability of the UE to support the full-duplex communication mode.

23. The method of claim 1, wherein the capability of the UE to support the simultaneous uplink transmissions and the cross-link interference measurements is based at least in part on the UE supporting the full-duplex communication mode.

24. A method for wireless communication at a network entity, comprising:
receiving a message indicating a capability of a UE to support simultaneous uplink transmissions and cross-link interference measurements on respective resources while operating in a full-duplex communication mode; and
receiving an uplink transmission during a first resource that at least partially overlaps in a time domain with a second resource configured for a cross-link interference measurement in accordance with the capability.

25. The method of claim 24, further comprising:
transmitting a resource allocation for a plurality of resources including the first resource, the plurality of resources being associated with intra-cell cross-link interference measurements, wherein the resource allocation is based at least in part on the capability comprising a capability of the UE to support simultaneous intra-cell cross-link interference measurements and uplink transmissions.

26. The method of claim 24, further comprising:
transmitting a resource allocation for a plurality of resources including the first resource, respective resources of the plurality of resources being associated with either intra-cell cross-link interference measurements or inter-cell cross-link interference measurements, wherein the resource allocation is based at least in part on the capability comprising a capability of the UE to support simultaneous intra-cell cross-link interference measurements and uplink transmissions; and
transmitting a third message comprising an indication to perform the intra-cell cross-link interference measurements or the inter-cell cross-link interference measurements, wherein the indication is based at least in part on the capability.

27. The method of claim 24, further comprising:
transmitting a resource allocation for a plurality of resources including the first resource, respective resources of the plurality of resources being associated with either intra-cell cross-link interference measurements or inter-cell cross-link interference measurements, wherein the resource allocation is based at least in part on the capability; and
transmitting a third message comprising an indication of which resources of the plurality of resources are associated with the simultaneous uplink transmissions and the cross-link interference measurements or associated with cross-link interference measurements without simultaneous uplink transmissions, wherein the indication is based at least in part on the capability.

28. The method of claim 24, further comprising:
transmitting a resource allocation for a plurality of resources, the plurality of resources comprising a first subset of resources associated with intra-cell cross-link interference measurements and a second subset of resources associated with inter-cell cross-link interference measurements.

29. An apparatus for wireless communication at a user equipment (UE), comprising:
a processor;
memory coupled with the processor; and
instructions stored in the memory and executable by the processor to cause the apparatus to:
transmit a message indicating a capability of the UE to support simultaneous uplink transmissions and cross-link interference measurements on respective resources while operating in a full-duplex communication mode; and
perform a cross-link interference measurement or an uplink transmission, or both, in accordance with the capability, wherein the cross-link interference measurement occurs during a first resource and the uplink transmission occurs during a second resource that at least partially overlaps in a time domain with the first resource.

30. An apparatus for wireless communication at a network entity, comprising:
a processor;
memory coupled with the processor; and
instructions stored in the memory and executable by the processor to cause the apparatus to:
receive a message indicating a capability of a UE to support simultaneous uplink transmissions and cross-link interference measurements on respective resources while operating in a full-duplex communication mode; and
receive an uplink transmission during a first resource that at least partially overlaps in a time domain with a second resource configured for a cross-link interference measurement in accordance with the capability.
